(19) United States
(12) Patent Application Publication
(10) Pub. No.: US 2026/0169401 A1
(43) Pub. Date: Jun. 18, 2026

(54) ELECTROPHOTOGRAPHIC MEMBER, ELECTROPHOTOGRAPHIC PROCESS CARTRIDGE, ELECTROPHOTOGRAPHIC IMAGE FORMING APPARATUS, AND COPOLYMER

(71) Applicant: CANON KABUSHIKI KAISHA, Tokyo (JP)

(72) Inventors: TAKASHI KOYANAGI, Shizuoka (JP); SOUYA YAMANE, Shizuoka (JP); MASAKI YAMADA, Shizuoka (JP)

(21) Appl. No.: 19/461,448

(22) Filed: Jan. 27, 2026

Related U.S. Application Data
(63) Continuation of application No. PCT/JP2024/029282, filed on Aug. 19, 2024.

(30) Foreign Application Priority Data
Aug. 23, 2023 (JP) 2023-135496

(51) Int. Cl. G03G 15/08; C08F 228/02; G03G 5/05; G03G 21/18

(52) U.S. Cl. CPC G03G 15/0818; C08F 228/02; G03G 5/0589; G03G 21/1814; C08F 2800/10

(57) ABSTRACT

An electrophotographic member having a conductive substrate and a conductive layer on the substrate, wherein the conductive layer contains a compound having a structure represented by formula (1) and a structure represented by formula (2): in formula (1), R¹ represents a hydrogen atom or a methyl group, R² represents a linear or branched alkylene group having 1 to 6 carbon atoms, R³ represents an alkyl group having 1 to 6 carbon atoms, A1 represents a linking group including a structure represented by (—CH₂CH₂—O—); in formula (2), R¹² represents a hydrogen atom or a methyl group, R¹³ represents a linear or branched alkylene group having 1 to 7 carbon atoms, R¹⁴ represents a fluorine atom or a linear or branched perfluoroalkyl group having 1 to 4 carbon atoms, and X⁺ represents at least one selected from the group consisting of a lithium ion, a sodium ion, and a potassium ion.

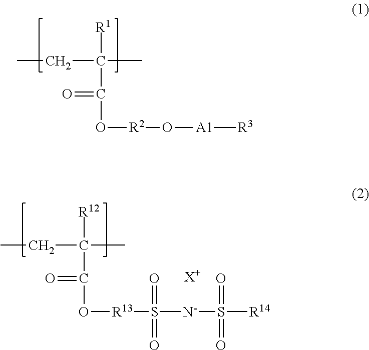

### CROSS-REFERENCE TO RELATED APPLICATIONS

This application is a Continuation of International Patent Application No. PCT/JP2024/029282, filed Aug. 19, 2024, which claims the benefit of Japanese Patent Application No. 2023-135496, filed Aug. 23, 2023, both of which are hereby incorporated by reference herein in their entirety.

### BACKGROUND

### Field of the Technology

The present disclosure relates to an electrophotographic member incorporated into an apparatus using an electrophotographic system. The present disclosure also relates to an electrophotographic process cartridge and an electrophotographic image forming apparatus using the electrophotographic member. The present disclosure also relates to a copolymer.

### Description of the Related Art

In an electrophotographic image forming apparatus (also referred to as “electrophotographic apparatus”), electrophotographic members equipped with conductive layers are used, examples thereof including a developing member, a charging member, a toner supply member, and a cleaning member. The conductive layer of an electrophotographic member has an electrical resistance controlled, for example, within the range of 1.0×10⁵ to 1.0×10⁹Ω. Furthermore, the conductivity needs to be uniform throughout the entire member and stable over time. Examples of conducting agents used to impart a desired conductivity to the conductive layer include conductive particles such as carbon black and ionic conducting agents such as salt compounds of sulfonylimide anions and metal cations.

Electroconductive rollers containing conductive particles such as carbon black have the advantage of being less susceptible to changes such as increased resistance due to uneven distribution of conductive components, even when energized over long periods of time. However, conductive particles such as carbon black are difficult to disperse uniformly, which can result in localized areas of high or low resistance. Compared to electronically conductive rollers, ionic conductive rollers containing ionic conducting agents can reduce uneven electrical resistance caused by uneven dispersion of the conducting agent, making it less likely that localized areas of high or low resistance will occur. As a result, with a developing roller, the photosensitive member can be uniformly developed with a developer, and the photosensitive member surface can be uniformly charged with a charging roller.

Japanese Patent Laid-Open No. 2004-163825 discloses a conductive roller formed using a polymer composition primarily including a chlorine-free and bromine-free polymer as a main component and also containing a salt with an anion having a fluoro group and a sulfonyl group.

In recent years, electrophotographic apparatuses have been required to maintain high image quality and high durability even in increasingly harsh environments. The inventors installed the conductive roller described in Japanese Patent Laid-Open No. 2004-163825 as a developing roller in an electrophotographic process cartridge and used this process cartridge to output a large number of electrophotographic images in an environment at a temperature of 0° C. As a result, as the number of output sheets increased, ghosting was sometimes observed in the electrophotographic images.

### SUMMARY

At least one aspect of the present disclosure is directed at providing an electrophotographic member that contributes to the stable formation of high-quality electrophotographic images in low-temperature environments.

At least one aspect of the present disclosure is directed at providing an electrophotographic process cartridge that contributes to the stable formation of high-quality electrophotographic images.

At least one aspect of the present disclosure is directed at providing an electrophotographic image forming apparatus capable of stably forming high-quality electrophotographic images.

At least one aspect of the present disclosure is directed at providing a copolymer that contributes to effective ion dissociation.

According to at least one aspect of the present disclosure, there is provided an electrophotographic member having a conductive substrate and a conductive layer on the substrate, wherein the conductive layer comprises a compound having a structure represented by formula (1) and a structure represented by formula (2):

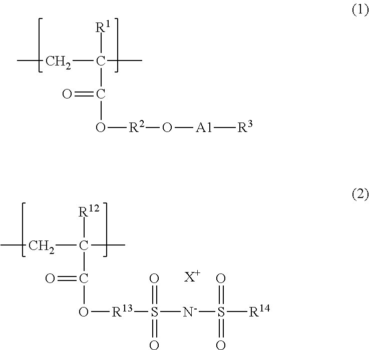

in formula (1), R¹ represents a hydrogen atom or a methyl group, R² represents a linear or branched alkylene group having 1 to 6 carbon atoms, R³ represents an alkyl group having 1 to 6 carbon atoms, A1 represents a linking group including a structure represented by (—CH₂CH₂—O—); in formula (2), R¹² represents a hydrogen atom or a methyl group, R¹³ represents a linear or branched alkylene group having 1 to 7 carbon atoms, R¹⁴ represents a fluorine atom or a linear or branched perfluoroalkyl group having 1 to 4 carbon atoms, and X⁺ represents at least one selected from the group consisting of a lithium ion, a sodium ion, and a potassium ion.

Features of the present disclosure will become apparent from the following description of embodiments with reference to the attached drawings.

### BRIEF DESCRIPTION OF THE DRAWINGS

FIGS. 1A to 1C are schematic cross-sectional views of an example of an electrophotographic roller according to one aspect of the present disclosure.

FIG. 2 shows a schematic configuration of an example of a process cartridge according to one aspect of the present disclosure.

FIG. 3 is a schematic cross-sectional view of an example of an electrophotographic apparatus according to one aspect of the present disclosure.

FIGS. 4A and 4B show schematic configurations of a jig for evaluating the resistance value of a developing roller.

FIG. 5 is an image diagram illustrating a mechanism according to one aspect of the present disclosure.

FIG. 6 is a schematic cross-sectional view of an example of a blade member according to one aspect of the present disclosure.

### DESCRIPTION OF THE EMBODIMENTS

Unless otherwise specified, descriptions of numerical ranges such as “from XX to YY” or “XX to YY” in the present disclosure include the numbers at the upper and lower limits of the range. When numerical ranges are described in stages, the upper and lower limits of each of each numerical range may be combined arbitrarily. In the present disclosure, wording such as “at least one selected from the group consisting of XX, YY and ZZ” means any of: XX; YY; ZZ; a combination of XX and YY; a combination of XX and ZZ; a combination of YY and ZZ; or a combination of XX and YY and ZZ.

In an electrophotographic image output test conducted in a low-temperature environment by using the conductive roller according to Japanese Patent Laid-Open No. 2004-163825 described above, the present inventors confirmed that the electrical resistance of the surface of the conductive roller increased immediately after ghosting occurred. From this, it was inferred that the occurrence of ghosting is due to charge accumulation on the conductive roller that follows an increase in the number of electrophotographic image outputs.

Based on this consideration, the present inventors conducted extensive research and discovered that the following electrophotographic member will contribute to solving the aforementioned problems.

That is, the electrophotographic member according to one embodiment of the present disclosure is an electrophotographic member having a conductive substrate and a conductive layer on the substrate, wherein the conductive layer comprises a compound having a structure represented by formula (1) and a structure represented by formula (2):

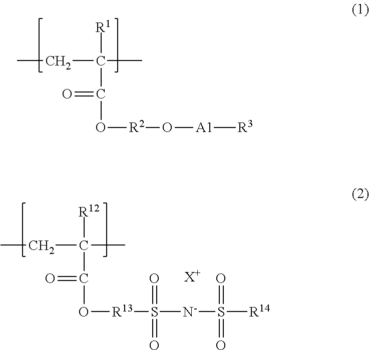

in formula (1), R¹ represents a hydrogen atom or a methyl group, R² represents a linear or branched alkylene group having 1 to 6 carbon atoms, R³ represents an alkyl group having 1 to 6 carbon atoms, A1 represents a linking group including a structure represented by (—CH₂CH₂—O—); in formula (2), R¹² represents a hydrogen atom or a methyl group, R¹³ represents a linear or branched alkylene group having 1 to 7 carbon atoms, R¹⁴ represents a fluorine atom or a linear or branched perfluoroalkyl group having 1 to 4 carbon atoms, and X⁺ represents at least one selected from the group consisting of a lithium ion, a sodium ion, and a potassium ion.

The inventors speculate that the reason why an electrophotographic member having the above configuration is less likely to cause ghosting, even when used to form multiple electrophotographic images in a low-temperature environment, is as follows.

Generally, compounds containing strongly Lewis acidic or Lewis basic chemical species form crystals (ionic crystals) due to strong electrostatic interactions thereof. In such cases, the compound alone does not undergo ionic dissociation. To achieve conductivity in such compounds, the anions and cations have to be dissociated. To achieve this, it is effective, for example, to add water to solvate the cations, thereby stabilizing them. Thus, to dissociate compounds that exhibit strong electrostatic interactions, the dissociated chemical species need to be stabilized.

Compared to organic cations, metal cations have a smaller ionic radius and higher mobility. Therefore, even if metal cations are polarized by energization when a voltage is applied, they are expected to diffuse quickly and uniformly once the voltage is removed. Metal cations are thus more suitable because an increase in resistance such as electrical degradation is unlikely to occur.

Japanese Patent Laid-Open No. 2004-163825 relates to a technique for causing a polyether-containing polymer or a polymer containing a cyan group to be co-present with a salt containing an anion having a fluoro group and a sulfonyl group. In Japanese Patent Laid-Open No. 2004-163825, the counter cation of the anion is lithium. Lithium is an ionic species with strong Lewis acidity and exhibits strong ionic bonding, making it difficult to dissociate and resulting in low conductivity when the salt is used alone. Therefore, the disclosed idea is to stabilize the cations, which are generated by dissociation, with molecules containing electron-rich functional groups, thereby promoting dissociation and improving conductivity.

Meanwhile, in an image output test conducted by the inventors, increase in resistance of the developing roller was observed at the final stage of image output in a low-temperature environment such as 0° C. This is thought to be caused by the lack of spatial proximity of the structure serving to stabilize the cations due to reduced molecular mobility at low temperatures. As another reason, it was considered that even when spatial proximity is achieved, the entire ionic molecule, not just the cation, is attracted, and as a result, dissociation of the ions does not occur.

To solve the above problems, a conducting agent that satisfies the following conditions (i) and (ii) is believed to be effective.
(i) The structure that stabilizes a cation is in spatial proximity.
(ii) As a cation is attracted, an anion remains in place.

The inventors investigated molecular structures of compounds that satisfy conditions (i) and (ii). As a result, it was found that suitable functionality can be obtained by including a compound having the structure represented by formula (1) and the structure represented by formula (2).

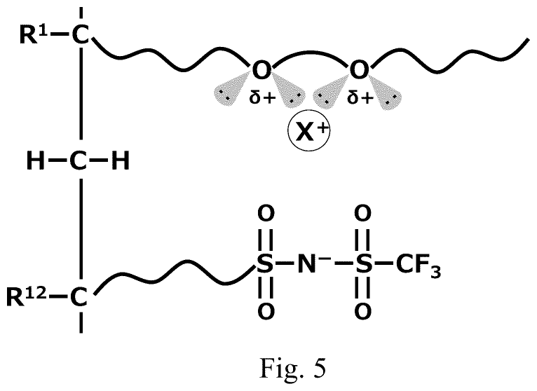

In a compound having the structure represented by formula (1) and the structure represented by formula (2), a sulfonylimide anion and a metal cation, which are the ionic components, and an ether structure that is expected to stabilize the cation, are copresent in the same molecule. Furthermore, because the ionic components are immobilized at the tip of the acrylic structure, it is considered that when the ether component attracts the cation, the anion is not attracted, resulting in effective ion dissociation (see the image diagram in FIG. 5).

Furthermore, even more suitable functionality can be achieved by including a copolymer having the structure represented by formula (1) and the structure represented by formula (2) as the copolymerization components.

An example of a copolymer having the structure represented by formula (1) and the structure represented by formula (2) is the vinyl copolymer described below.

### <<Ionic Conducting Agent>>

The ionic conducting agent according to the present disclosure includes a compound having the structure represented by formula (1) and the structure represented by formula (2), and more preferably includes a compound (preferably a copolymer) having the structure represented by formula (1) and the structure represented by formula (2).

Moreover, it is preferable that A1 in formula (1) further includes a structure represented by (—CH₂—CH(CH₃)—O—). It is even more preferable that the structure represented by formula (1) is the structure represented by formula (1-1) below.

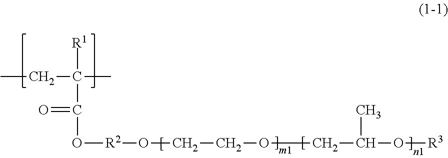

R² represents a linear or branched alkylene group having 1 to 6 carbon atoms (preferably 1 to 4, more preferably 2 to 4),
R³ represents an alkyl group having 1 to 6 carbon atoms (preferably 1 to 4, more preferably 1),
m1 and n1 are average addition mole numbers, m1 is an integer of 1 or greater (preferably 1 to 110, more preferably 13 to 46), and n1 is an integer of 0 or greater (preferably 5% to 25% of m1, more preferably 11% to 25% of m1).

The arrangement of the structure represented by (—CH₂—CH₂—O—) and the structure represented by (—CH₂—CH(CH₃)—O—) may be a block copolymer or a random copolymer.

When the compound is a copolymer, the number-average molecular weight (Mn) of the copolymer is preferably 500 to 100,000 (more preferably 1000 to 50,000) from the viewpoint of balancing bleed-out and compatibility.

Furthermore, from the viewpoint of realizing the above mechanism, the molar ratio of the structure represented by formula (1) to the structure represented by formula (2) in the copolymer (structure represented by formula (1): structure represented by formula (2)) is preferably 60:40 to 95:5, and more preferably 75:25 to 90:10.

The content of the compound having the structure represented by formula (1) and the structure represented by formula (2) in the conductive layer is preferably 0.50% by mass to 5.0% by mass. Furthermore, when the conductive layer contains a binder resin, the content is preferably 1.0 part by mass to 5.0 parts by mass relative to the binder resin.

The following raw materials can be used to obtain the compounds used in the ionic conducting agent according to the present disclosure.
Polyether mono(meth)acrylates
Sulfonylimide-based ionic compounds having an unsaturated reactive functional group

### [Polyether Mono(meth)acrylates]

Polyether mono(meth)acrylates can form a structure represented by formula (1) (preferably formula (1-1)). Examples of polyether mono(meth)acrylates include at least one selected from the group consisting of polyethylene glycol mono(meth)acrylate and mono(meth)acrylate of polyethylene glycol-propylene glycol copolymer. When using mono(meth)acrylate of polyethylene glycol-propylene glycol copolymer, the molar ratio of ethylene glycol structure to propylene glycol structure is preferably 100:0 to 50:50, and more preferably 80:20 to 95:5.

When the molar ratio of ethylene glycol structure to propylene glycol structure is within this range, the transportability of ions represented by X⁺, such as lithium ions, by polyethylene glycol can be maintained at a high level.

Polyether mono(meth)acrylate is represented, for example, by the following formula (1′).

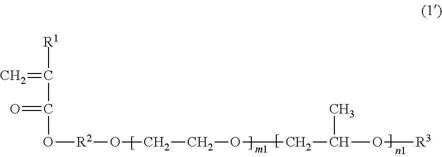

The structure represented by formula (1) (preferably formula (1-1)) can be obtained, for example, by using a polyether polyol obtained by ring-opening polymerization of ethylene oxide and propylene oxide. In formulas (1-1) and (1′), the arrangement of the ethylene oxide structure represented by (—CH₂—CH₂—O—) and the propylene oxide structure represented by (—CH₂—CH(CH₃)—O—) may be a block copolymer or a random copolymer. Random copolymerization is preferred.

Polyether mono(meth)acrylate may be synthesized by known methods, or a commercially available product may be used. A known method involves adding ethylene oxide/propylene oxide to an alcohol as a starting material to obtain a polyether monool, which is then reacted with (meth)acrylic acid to obtain a polyether mono(meth)acrylate.

### [Sulfonylimide Anion Group]

The ionic conducting agent according to the present disclosure is characterized by containing a compound having the structure represented by formula (2) above.

Examples of compounds capable of forming the structure represented by formula (2) include sulfonylimide-based ionic compounds having an unsaturated reactive functional group, as represented by formulas C-1 to C-8 below.

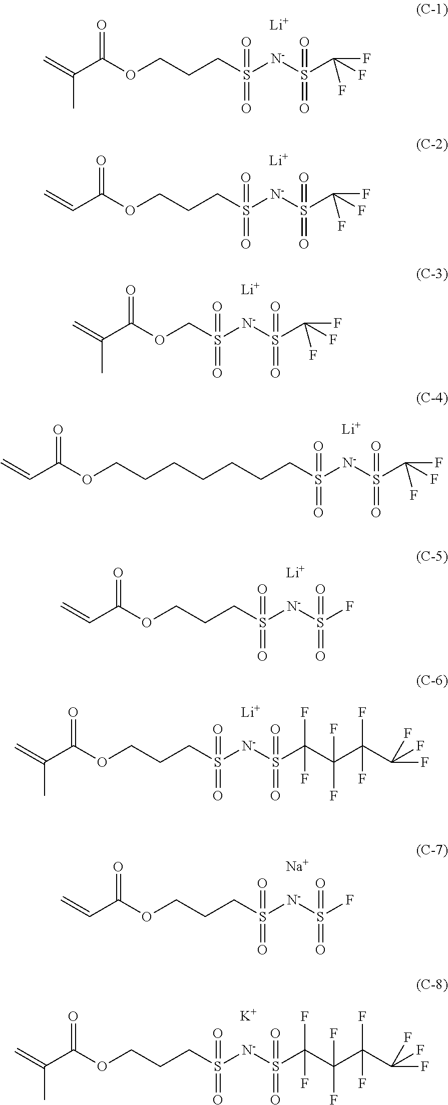

The above ionic compounds can be synthesized using known methods.

By reacting the above polyether mono(meth)acrylate with a sulfonylimide-based ionic compound having an unsaturated reactive functional group, a compound having the structure represented by formula (1) above and the structure represented by formula (2) above can be obtained.

The content of the structure represented by formula (2) in the structure of the compound is preferably 20 parts by mass to 80 parts by mass, and particularly preferably 30 parts by mass to 70 parts by mass, per 100 parts by mass of the structure represented by formula (1).

When the mass ratio of the structure represented by formula (2) is within this range, a cation-stabilizing component is abundantly present while a sufficient amount of metal cations is contained. As a result, dissociation of ions occurs suitably, and improvement in ionic conductivity is expected.

The state after these reactions can be confirmed by analysis using known means such as pyrolysis GC/MS, FT-IR, and NMR.

### <Cation>

The cation X⁺ in formula (2) can be at least one selected from the group consisting of lithium ion, sodium ion, and potassium ion. Among these cations, lithium ion is particularly preferred due to small ionic radius and high mobility thereof.

### <<Electrophotographic Member>>

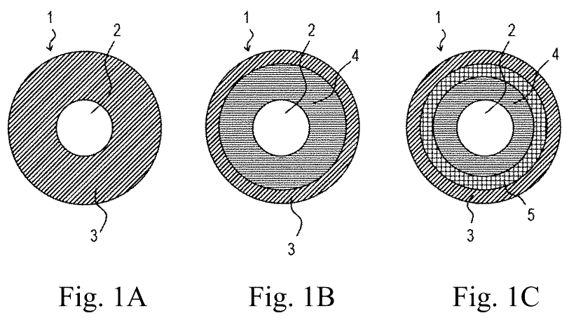

An electrophotographic member according to one embodiment of the present disclosure has a conductive substrate and a surface layer provided on the substrate. As an example of the electrophotographic member, a roller-shaped electrophotographic member (electrophotographic roller) is shown in FIGS. 1A to 1C. The electrophotographic member 1 shown in FIG. 1A is configured of a conductive substrate 2 and a surface layer 3 provided on the outer periphery thereof, the surface layer being made of a conductive layer containing a compound having a structure represented by formula (1) and a structure represented by formula (2). As shown in FIG. 1B, an elastic layer 4 may be provided between the substrate 2 and the surface layer 3. Furthermore, as shown in FIG. 1C, the electrophotographic member 1 may have a three-layer structure in which an intermediate layer 5 is further disposed between the elastic layer 4 and the surface layer 3, or a multi-layer structure in which multiple intermediate layers 5 are disposed. The conductive layer may be a resin layer made of a conductive resin.

The layer configuration of the electrophotographic member 1 is not limited to the configuration shown in FIGS. 1A to 1C. The electrophotographic member 1 may have a configuration including an additional surface layer on the substrate 2 and a conductive layer provided on the periphery thereof, for example, by laminating one or more other resin layers or protective layers on the periphery of the conductive layer. Alternative configuration has a conductive layer as the intermediate layer 5. Among these, to further enhance the effects of the present disclosure, the electrophotographic member of the present disclosure is preferably configured to have a conductive layer as the outermost surface layer 3, as shown in FIGS. 1A to 1C. Furthermore, the electrophotographic member 1 preferably has the elastic layer 4.

An electrophotographic member according to one aspect of the present disclosure can be used, for example, as a developer carrying member, a charging member, a developer supply/stripping member, a developer regulating member, and a cleaning blade. The electrophotographic member is particularly suitable for use as a developer carrying member and a developer regulating member. The configuration of the electrophotographic member according to one embodiment of the present disclosure is described in detail below.

### <Surface Layer>

The conductive layer of the electrophotographic member preferably contains a binder resin, and it is even more preferable that the binder resin contains an ether structure. A specific embodiment is, for example, one in which the outermost conductive layer of an electrophotographic roller contains a binder resin. This is because, as mentioned above, the binder resin exhibits the effect of stabilizing metal cations. Furthermore, from the viewpoint of the strength of the electrophotographic member and friction thereof with other members, the binder resin is preferably polyurethane, and a crosslinked urethane resin is particularly preferable.

### [Crosslinked Urethane Resin]

Crosslinked urethane resin is obtained by forming urethane groups by reacting a polyol containing a hydroxyl group with an isocyanate compound. The term “crosslinked” here means that one or both of the raw materials of the urethane resin selected from the group consisting of polyols and isocyanate compounds has three or more reactive functional groups, and thus has a three-dimensional network structure. Such cross-linked urethane resins possess excellent flexibility and high strength.

Urethane resins can be obtained from polyols and isocyanate compounds, and optionally, chain extenders. Examples of polyols used to make urethane resins include polyether polyols, polyester polyols, polycarbonate polyols, polyolefin polyols, acrylic polyols, and mixtures thereof. Examples of isocyanate compounds used to make urethane are listed hereinbelow.

Tolylene diisocyanate (TDI), diphenylmethane diisocyanate (MDI), naphthalene diisocyanate (NDI), tolidine diisocyanate (TODI), hexamethylene diisocyanate (HDI), isophorone diisocyanate (IPDI), phenylene diisocyanate (PPDI), xylylene diisocyanate (XDI), tetramethylxylylene diisocyanate (TMXDI), cyclohexane diisocyanate, and mixtures thereof.

Examples of optional chain extenders include difunctional low-molecular-weight diols such as ethylene glycol, 1,4-butanediol, and 3-methylpentanediol, trifunctional low-molecular-weight triols such as trimethylolpropane, and mixtures thereof. Also may be used prepolymer-type isocyanate compounds having terminal isocyanate groups, such compounds being obtained by preliminarily reacting the above-mentioned isocyanate compounds with various polyols in a state where the isocyanate groups are in excess relative to the hydroxyl groups. Furthermore, materials in which the isocyanate groups are blocked with various blocking agents, such as methyl ethyl ketone (MEK) oxime, may also be used as these isocyanate compounds.

With either material, a urethane resin can be obtained by reacting the polyol and isocyanate compound by heating. Preferably, the polyol and/or the isocyanate compound has a branched structure and three or more functional groups, because the urethane resin obtained becomes a crosslinked urethane resin.

Furthermore, from the viewpoint of stabilizing the metal cations, it is particularly preferable that the polyol and/or the isocyanate compound has an ethylene oxide structure or a propionoxide structure.

### [Other Components]

In addition to the above, the surface layer can contain conductive materials, crosslinkers, plasticizers, fillers, extenders, vulcanizing agents, vulcanization aids, crosslinking aids, antioxidants, antiaging agents, processing aids, leveling agents, etc., provided that the functionality of the surface layer is not impaired. Furthermore, if surface roughness is required for the surface layer, fine particles can be added to impart roughness to the surface layer. Specifically, fine particles of polyurethane resin, polyester resin, polyether resin, polyamide resin, acrylic resin, polycarbonate resin, etc. can be used. The volume-average particle diameter of the fine particles is preferably from 1.0 μm to 30 μm, and the surface roughness (ten-point average roughness) Rzjis formed by the fine particles is preferably from 0.1 μm to 20 μm. Rzjis is a value measured based on JIS B0601 (1994).

### <Substrate>

The conductive substrate 2 functions as an electrode and support member for the electrophotographic member 1. The substrate is composed of conductive materials such as metals or alloys such as aluminum, copper alloys, and stainless steel; iron plated with chromium or nickel; and conductive synthetic resins.

A primer may be applied to the surface of the substrate to improve adhesion between the substrate and the elastic layer (described below). Examples of primers that can be used include silane coupling agent-based primers, and urethane, acrylic, polyester, polyether, or epoxy-based thermosetting or thermoplastic resins. Examples of commercially available primers are listed hereinbelow.

“DY39-051,” “DY39-012,” and “DY39-115” (all product names, manufactured by Dow Corning Toray Co., Ltd.); “X-33-173,” “PRIMER-NO. 4,” “PRIMER-NO. 32,” and “PRIMER-NO. 35” (all product names, manufactured by Shin-Etsu Chemical Co., Ltd.); “XP81-405,” “XP81-A6361,” “XP81-B7015,” “ME21,” “ME151,” “ME153,” and “XC9214” (all product names, manufactured by Momentive Performance Materials Japan, LLC).

Known alkoxysilanes and titanic acid esters may be added to the primer to improve adhesion thereof. Specific examples of alkoxysilanes and titanic acid esters include tetramethoxysilane, tetraethoxysilane, tetra-n-butoxysilane, tetraethoxytitanium, tetraisopropoxytitanium, and tetra-n-butoxytitanium. These are preferably added in amounts of 0.1 parts by mass to 20 parts by mass per 100 parts by mass of primer.

### <Elastic Layer>

In the case of a roller-shaped electrophotographic member, i.e., an electrophotographic roller, the elastic layer 4 functions to provide the electrophotographic member 1 with the elasticity necessary to form a nip of a predetermined width at the contact point between the electrophotographic member 1 and the photosensitive member. The elastic layer 4 is preferably a molded body made of a rubber material. Various rubber materials conventionally used in conductive rubber rollers can be used as the rubber material. Specific examples of rubbers used as the rubber material include ethylene-propylene-diene copolymer rubber (EPDM), acrylonitrile-butadiene rubber (NBR), chloroprene rubber (CR), natural rubber (NR), isoprene rubber (IR), styrene-butadiene rubber (SBR), fluororubber, silicone rubber, epichlorohydrin rubber, NBR hydride, polysulfide rubber, and urethane rubber. These may be used alone or in combination of two or more. Among these, silicone rubber is preferred, particularly from the standpoint of stability against deformation, such as setting performance. Examples of silicone rubber include polydimethylsiloxane, polymethyltrifluoropropylsiloxane, polymethylvinylsiloxane, polyphenylvinylsiloxane, and copolymers of these polysiloxanes.

Various additives such as conducting agents, non-conductive fillers, crosslinking agents, and catalysts may also be blended, as appropriate, in the elastic layer 4. Fine particles of carbon black, conductive metals such as aluminum and copper, and conductive metal oxides such as zinc oxide, tin oxide, and titanium oxide can be used as conductivity-imparting agents. Among these, carbon black is preferred because it provides good conductivity at relatively low addition levels.

Specific examples of carbon black include conductive carbon blacks such as Ketjen black (product name, manufactured by Lion Corporation) and acetylene black, rubber carbon blacks such as SAF, ISAF, HAF, FEF, GPF, SRF, FT, and MT, oxidation-treated carbon blacks for color ink and pyrolytic carbon blacks. These may be used alone or in combination of two or more. When using carbon black as a conductivity-imparting agent, it is preferable to blend 10 parts by mass to 80 parts by mass of carbon black per 100 parts by mass of rubber in the rubber material.

Further, examples of non-conductive fillers include silica, quartz powder, titanium oxide, zinc oxide, and calcium carbonate. Examples of crosslinking agents include di-t-butyl peroxide, 2,5-dimethyl-2,5-di(t-butylperoxy)hexane, and dicumyl peroxide. Examples of catalysts include platinum-based catalysts, rhodium-based catalysts, and palladium-based catalysts, with platinum-based catalysts being particularly preferred.

The elastic layer 4 may be formed from multiple layers. An intermediate layer 5 may be provided between the substrate 2 and the elastic layer 4, and between the elastic layer 4 and the surface layer 3. The thickness of the elastic layer 4 is preferably 0.25 mm to 8.00 mm, and more preferably 0.30 mm to 3.00 mm.

### <<Electrophotographic Apparatus>>

The electrophotographic member disclosed herein can be suitably used as a developer carrying member or a developer regulating member in an electrophotographic apparatus. The electrophotographic members can be used in non-contact and contact developing devices using magnetic or non-magnetic single-component toner, as well as developing devices using two-component toner.

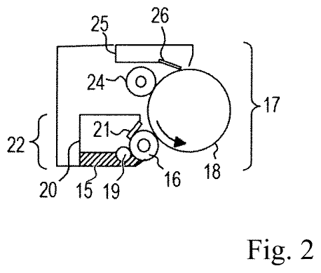

FIG. 2 is a schematic cross-sectional view showing an example of an electrophotographic apparatus equipped with the electrophotographic member according to the present disclosure as a developing roller of a contact-type developing device using mono-component toner. As shown in FIG. 2, a developing device 22 is detachably mounted on the electrophotographic apparatus. The developing device 22 comprises a toner container 20 containing a mono-component toner 15, a developing roller 16, a toner supply roller 19 that supplies toner to the developing roller 16, and a developing blade 21 that regulates the thickness of the toner layer on the developing roller 16. The developing roller 16 is located in an opening extending longitudinally within the toner container 20 and is arranged to face a photosensitive member 18. A process cartridge 17, which comprises the photosensitive member 18, a cleaning blade 26, a waste toner container 25, and a charging roller 24, is detachably mounted on the electrophotographic apparatus. The photosensitive member 18, cleaning blade 26, waste toner container 25, and charging roller 24 may be located within the main body of the electrophotographic apparatus.

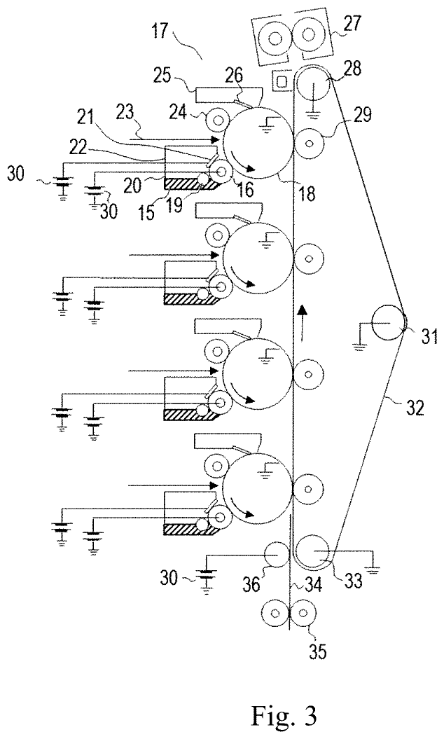

The printing operation of the electrophotographic apparatus is described below. FIG. 3 is a schematic cross-sectional view of an example of an electrophotographic apparatus according to one aspect of the present disclosure. The photosensitive member 18 rotates in the direction of the arrow and is uniformly charged by the charging roller 24 for charging the photosensitive member 18. Next, an electrostatic latent image is formed on the surface of the photosensitive member 18 by a laser beam 23, which serves as an exposure means. The electrostatic latent image is visualized as a toner image (developed) by applying toner 15 with the developing device 22, which is placed in contact with the photosensitive member 18. This development is known as the so-called reversal development, in which a toner image is formed in the exposed area. The toner image formed on the photosensitive member 18 is transferred to a recording medium, i.e., paper 34, by a transfer roller 29, which serves as a transfer member. The paper 34 is fed into the device by a paper feed roller 35 and an attraction roller 36 and transported between the photosensitive member 18 and the transfer roller 29 by an endless transfer/transport belt 32. The transfer/transport belt 32 is driven by a driven roller 33, a drive roller 28, and a tension roller 31. A voltage is applied to the transfer roller 29 and the attraction roller 36 from a bias power supply 30. The paper 34 with the transferred toner image is fixed by a fixing device 27 and then ejected from the device, completing the printing operation. Meanwhile, untransferred toner remaining on the photosensitive member 18 without being transferred is scraped off by the cleaning blade 26, which is a cleaning member for cleaning the photosensitive member surface, and stored in the waste toner container 25. The cleaned photosensitive member 18 repeatedly performs the above printing operation.

### <<Process Cartridge>>

The electrophotographic member according to the present disclosure can be suitably used as a developing member in a process cartridge, such as a developer carrying member, a developer supply/stripping member, and a developer regulating member.

### EXAMPLES

The present disclosure is described in detail below using specific examples, but the technical scope of the present disclosure is not limited to these examples.

### <<Preparation of Raw Materials>>

### <Synthesis of Polymerizable Monomers: Polyether Monoacrylates>

First, polyether acrylates forming the structure represented by formula (1) were synthesized. Examples of the synthesis of a polyether monoacrylates capable of forming the structure represented by formula (1) are shown below.

### (Polyether Monoacrylate A-1)

A total of 15.5 parts by mass of 1-hexanol (manufactured by Tokyo Chemical Industry Co., Ltd.) and 2 parts by mass of potassium hydroxide (manufactured by Kojundo Chemical Laboratory Co., Ltd.) were placed in an autoclave and stirred under reduced pressure at 120° C. to dissolve and dehydrate. Next, the system was depressurized to −0.1 MPa at 100° C., and 1041 parts by mass of a gas mixture of ethylene oxide and propylene oxide at a molar fraction of 8:2 was continuously introduced over 260 min while maintaining the pressure inside the vessel at approximately 0.5 MPa. The reaction was continued for 180 min while maintaining the temperature at 100° C., until the pressure inside the vessel dropped to 0.2 MPa or less. The temperature was then raised to 130° C. over 30 min, and stirring was performed until the change in pressure inside the vessel reached 0.01 MPa/30 min. A total of 20 parts by mass of purified water was added to the resulting polymer, followed by stirring at 90° C. for 30 min. After that, 50 g of an alkali adsorbent, Kyoward 600 (manufactured by Kyowa Chemical Industry Co., Ltd.), was added, followed by stirring for another 30 min. The alkali adsorbent was then removed by filtration, and the mixture was dried under reduced pressure at 130° C. to obtain a polyether monool with an Mn of 6000.

Next, 100 parts by mass of the resulting polyether monool, 1.26 parts by mass of acrylic acid (manufactured by Nippon Shokubai Co., Ltd.), 2.02 parts by mass of paratoluenesulfonic acid (manufactured by Tokyo Chemical Industry Co., Ltd.), 0.08 parts by mass of hydroquinone (manufactured by Tokyo Chemical Industry Co., Ltd.), and 250 mL of toluene were added to a Dean-Stark reactor equipped with a stirrer. The components were heated and stirred at 115° C., and the reaction was allowed to proceed for 5 h while removing the water produced by the reaction from the system.

The reaction liquid temperature was then lowered to room temperature, followed by washing twice with 120 g of 5% aqueous sodium hydroxide and then three times with 120 g of purified water. The organic phase was separated from the washed reaction liquid, and the solvent was removed under reduced pressure to obtain polyether monoacrylate A-1.

### (Polyether Monoacrylate A-2)

A total of 18.6 parts by mass of 1-hexanol (manufactured by Tokyo Chemical Industry Co., Ltd.) and 2 parts by mass of potassium hydroxide (manufactured by Kojundo Chemical Laboratory Co., Ltd.) were placed in an autoclave and stirred under reduced pressure at 120° C. to dissolve and dehydrate. Next, the system was depressurized to −0.1 MPa at 100° C., and 976 parts by mass of a gas mixture of ethylene oxide and propylene oxide at a molar fraction of 95:5 was continuously introduced over 240 min while maintaining the pressure inside the vessel at approximately 0.5 MPa. The reaction was continued for 180 min while maintaining the temperature at 100° C., until the pressure inside the vessel dropped to 0.2 MPa or less. The temperature was then raised to 130° C. over 30 min, and stirring was performed until the change in pressure inside the vessel reached 0.01 MPa/30 min. A total of 20 parts by mass of purified water was added to the resulting polymer, followed by stirring at 90° C. for 30 min. After that, 50 g of an alkali adsorbent, Kyoward 600 (manufactured by Kyowa Chemical Industry Co., Ltd.), was added, followed by stirring for another 30 min. The alkali adsorbent was then removed by filtration, and the mixture was dried under reduced pressure at 130° C. to obtain a polyether monool with an Mn of 5000.

Next, 100 parts by mass of the resulting polyether monool, 1.51 parts by mass of acrylic acid (manufactured by Nippon Shokubai Co., Ltd.), 2.42 parts by mass of paratoluenesulfonic acid (manufactured by Tokyo Chemical Industry Co., Ltd.), 0.08 parts by mass of hydroquinone (manufactured by Tokyo Chemical Industry Co., Ltd.), and 250 mL of toluene were added to a Dean-Stark reactor equipped with a stirrer. The components were heated and stirred at 115° C., and the reaction was allowed to proceed for 5 h while removing the water produced by the reaction from the system.

The reaction liquid temperature was then lowered to room temperature, followed by washing twice with 120 g of 5% aqueous sodium hydroxide and then three times with 120 g of purified water. The organic phase was separated from the washed reaction liquid, and the solvent was removed under reduced pressure to obtain polyether monoacrylate A-2.

### (Polyether Monoacrylate A-3)

Polyether monoacrylate A-3 was obtained in the same manner as polyether monoacrylate A-2, except that the molar fraction of the ethylene oxide/propylene oxide mixed gas was changed to 8:2.

### (Polyether Monoacrylate A-4)

A total of 33.7 parts by mass of 1-butanol (manufactured by Tokyo Chemical Industry Co., Ltd.) and 2 parts by mass of potassium hydroxide (manufactured by Kojundo Chemical Laboratory Co., Ltd.) were placed in an autoclave and stirred under reduced pressure at 120° C. to dissolve and dehydrate. Next, the system was depressurized to −0.1 MPa at 100° C., and 984 parts by mass of a gas mixture of ethylene oxide and propylene oxide at a molar fraction of 8:2 was continuously introduced over 240 min while maintaining the pressure inside the vessel at approximately 0.5 MPa. The reaction was continued for 150 min while maintaining the temperature at 100° C., until the pressure inside the vessel dropped to 0.2 MPa or less. The temperature was then raised to 130° C. over 30 min, and stirring was performed until the change in pressure inside the vessel reached 0.01 MPa/30 min. A total of 20 parts by mass of purified water was added to the resulting polymer, followed by stirring at 90° C. for 30 min. After that, 50 g of an alkali adsorbent, Kyoward 600 (manufactured by Kyowa Chemical Industry Co., Ltd.), was added, followed by stirring for another 30 min. The alkali adsorbent was then removed by filtration, and the mixture was dried under reduced pressure at 130° C. to obtain a polyether monool with an Mn of 2000.

Next, 100 parts by mass of the resulting polyether monool, 3.78 parts by mass of acrylic acid (manufactured by Nippon Shokubai Co., Ltd.), 6.05 parts by mass of paratoluenesulfonic acid (manufactured by Tokyo Chemical Industry Co., Ltd.), 0.11 parts by mass of hydroquinone (manufactured by Tokyo Chemical Industry Co., Ltd.), and 250 mL of toluene were added to a Dean-Stark reactor equipped with a stirrer. The components were heated and stirred at 115° C., and the reaction was allowed to proceed for 6 h while removing the water produced by the reaction from the system.

The reaction liquid temperature was then lowered to room temperature, followed by washing twice with 120 g of 5% aqueous sodium hydroxide and then three times with 120 g of purified water. The organic phase was separated from the washed reaction liquid, and the solvent was removed under reduced pressure to obtain polyether monoacrylate A-4.

### (Polyether Monoacrylate A-5)

A total of 67.4 parts by mass of 1-butanol (manufactured by Tokyo Chemical Industry Co., Ltd.) and 2 parts by mass of potassium hydroxide (manufactured by Kojundo Chemical Laboratory Co., Ltd.) were placed in an autoclave and stirred under reduced pressure at 120° C. to dissolve and dehydrate. Next, the system was depressurized to −0.1 MPa at 100° C., and 946 parts by mass of a gas mixture of ethylene oxide and propylene oxide at a molar fraction of 8:2 was continuously introduced over 240 min while maintaining the pressure inside the vessel at approximately 0.5 MPa. The reaction was continued for 130 min while maintaining the temperature at 100° C., until the pressure inside the vessel dropped to 0.2 MPa or less. The temperature was then raised to 130° C. over 30 min, and stirring was performed until the change in pressure inside the vessel reached 0.01 MPa/30 min. A total of 20 parts by mass of purified water was added to the resulting polymer, followed by stirring at 90° C. for 30 min. After that, 50 g of an alkali adsorbent, Kyoward 600 (manufactured by Kyowa Chemical Industry Co., Ltd.), was added, followed by stirring for another 30 min. The alkali adsorbent was then removed by filtration, and the mixture was dried under reduced pressure at 130° C. to obtain a polyether monool with an Mn of 1000.

Next, 100 parts by mass of the resulting polyether monool, 7.56 parts by mass of acrylic acid (manufactured by Nippon Shokubai Co., Ltd.), 12.1 parts by mass of paratoluenesulfonic acid (manufactured by Tokyo Chemical Industry Co., Ltd.), 0.11 parts by mass of hydroquinone (manufactured by Tokyo Chemical Industry Co., Ltd.), and 250 mL of toluene were added to a Dean-Stark reactor equipped with a stirrer. The components were heated and stirred at 115° C., and the reaction was allowed to proceed for 6 h while removing the water produced by the reaction from the system.

The reaction liquid temperature was then lowered to room temperature, followed by washing twice with 120 g of 5% aqueous sodium hydroxide and then three times with 120 g of purified water. The organic phase was separated from the washed reaction liquid, and the solvent was removed under reduced pressure to obtain polyether monoacrylate A-5.

### (Polyether Monoacrylate A-6)

A total of 112 parts by mass of 1-butanol (manufactured by Tokyo Chemical Industry Co., Ltd.) and 5 parts by mass of potassium hydroxide (manufactured by Kojundo Chemical Laboratory Co., Ltd.) were placed in an autoclave and stirred under reduced pressure at 120° C. to dissolve and dehydrate. Next, the system was depressurized to −0.1 MPa at 100° C., and 937 parts by mass of a gas mixture of ethylene oxide and propylene oxide at a molar fraction of 8:2 was continuously introduced over 240 min while maintaining the pressure inside the vessel at approximately 0.5 MPa. The reaction was continued for 120 min while maintaining the temperature at 100° C., until the pressure inside the vessel dropped to 0.2 MPa or less. The temperature was then raised to 130° C. over 30 min, and stirring was performed until the change in pressure inside the vessel reached 0.01 MPa/30 min. A total of 20 parts by mass of purified water was added to the resulting polymer, followed by stirring at 90° C. for 30 min. After that, 50 g of an alkali adsorbent, Kyoward 600 (manufactured by Kyowa Chemical Industry Co., Ltd.), was added, followed by stirring for another 30 min. The alkali adsorbent was then removed by filtration, and the mixture was dried under reduced pressure at 130° C. to obtain a polyether monool with an Mn of 600.

Next, 100 parts by mass of the resulting polyether monool, 12.6 parts by mass of acrylic acid (manufactured by Nippon Shokubai Co., Ltd.), 20.2 parts by mass of paratoluenesulfonic acid (manufactured by Tokyo Chemical Industry Co., Ltd.), 0.11 parts by mass of hydroquinone (manufactured by Tokyo Chemical Industry Co., Ltd.), and 250 mL of toluene were added to a Dean-Stark reactor equipped with a stirrer. The components were heated and stirred at 115° C., and the reaction was allowed to proceed for 6 h while removing the water produced by the reaction from the system.

The reaction liquid temperature was then lowered to room temperature, followed by washing twice with 120 g of 5% aqueous sodium hydroxide and then three times with 120 g of purified water. The organic phase was separated from the washed reaction liquid, and the solvent was removed under reduced pressure to obtain polyether monoacrylate A-6.

### (Polyether Monoacrylate A-7)

A total of 169 parts by mass of 1-butanol (manufactured by Tokyo Chemical Industry Co., Ltd.) and 8 parts by mass of potassium hydroxide (manufactured by Kojundo Chemical Laboratory Co., Ltd.) were placed in an autoclave and stirred under reduced pressure at 120° C. to dissolve and dehydrate. Next, the system was depressurized to −0.1 MPa at 100° C., and 927 parts by mass of a gas mixture of ethylene oxide and propylene oxide at a molar fraction of 8:2 was continuously introduced over 220 min while maintaining the pressure inside the vessel at approximately 0.5 MPa. The reaction was continued for 120 min while maintaining the temperature at 100° C., until the pressure inside the vessel dropped to 0.2 MPa or less. The temperature was then raised to 130° C. over 30 min, and stirring was performed until the change in pressure inside the vessel reached 0.01 MPa/30 min. A total of 20 parts by mass of purified water was added to the resulting polymer, followed by stirring at 90° C. for 30 min. After that, 50 g of an alkali adsorbent, Kyoward 600 (manufactured by Kyowa Chemical Industry Co., Ltd.), was added, followed by stirring for another 30 min. The alkali adsorbent was then removed by filtration, and the mixture was dried under reduced pressure at 130° C. to obtain a polyether monool with an Mn of 400.

Next, 100 parts by mass of the resulting polyether monool, 18.9 parts by mass of acrylic acid (manufactured by Nippon Shokubai Co., Ltd.), 24.2 parts by mass of paratoluenesulfonic acid (manufactured by Tokyo Chemical Industry Co., Ltd.), 0.11 parts by mass of hydroquinone (manufactured by Tokyo Chemical Industry Co., Ltd.), and 250 mL of toluene were added to a Dean-Stark reactor equipped with a stirrer. The components were heated and stirred at 115° C., and the reaction was allowed to proceed for 6 h while removing the water produced by the reaction from the system.

The reaction liquid temperature was then lowered to room temperature, followed by washing twice with 120 g of 5% aqueous sodium hydroxide and then three times with 120 g of purified water. The organic phase was separated from the washed reaction liquid, and the solvent was removed under reduced pressure to obtain polyether monoacrylate A-7.

### (Polyether Monoacrylate A-8)

Polyether monoacrylate A-8 was obtained in the same manner as polyether monoacrylate A-5, except that the molar fraction of the ethylene oxide/propylene oxide mixed gas was changed to 9:1.

### (Polyether Monoacrylate A-9)

Polyether monoacrylate A-9 was obtained in the same manner as polyether monoacrylate A-5, except that the molar fraction of the ethylene oxide/propylene oxide mixed gas was changed to 5:5.

### (Polyether Monomethacrylate A-10)

A polyether monool with an Mn of 600 was obtained in the same manner as polyether monoacrylate A-6, except that the molar fraction of the ethylene oxide/propylene oxide mixed gas was changed to 5:5.

Next, 100 parts by mass of the resulting polyether monool, 15.0 parts by mass of methacrylic acid (manufactured by Mitsubishi Gas Chemical Company, Inc.), 20.2 parts by mass of paratoluenesulfonic acid (manufactured by Tokyo Chemical Industry Co., Ltd.), 0.11 parts by mass of hydroquinone (manufactured by Tokyo Chemical Industry Co., Ltd.), and 250 mL of toluene were added to a Dean-Stark reactor equipped with a stirrer. The components were heated and stirred at 115° C., and the reaction was allowed to proceed for 6 h while removing the water produced by the reaction from the system.

The reaction liquid temperature was then lowered to room temperature, followed by washing twice with 120 g of 5% aqueous sodium hydroxide and then three times with 120 g of purified water. The organic phase was separated from the washed reaction liquid, and the solvent was removed under reduced pressure to obtain polyether monomethacrylate A-10.

### (Polyether Monomethacrylate A-11)

A polyether monool with an Mn of 400 was obtained in the same manner as polyether monoacrylate A-7, except that the molar fraction of the ethylene oxide/propylene oxide mixed gas was changed to 5:5.

Next, 100 parts by mass of the resulting polyether monool, 22.6 parts by mass of methacrylic acid (manufactured by Mitsubishi Gas Chemical Company, Inc.), 24.2 parts by mass of paratoluenesulfonic acid (manufactured by Tokyo Chemical Industry Co., Ltd.), 0.11 parts by mass of hydroquinone (manufactured by Tokyo Chemical Industry Co., Ltd.), and 250 mL of toluene were added to a Dean-Stark reactor equipped with a stirrer. The components were heated and stirred at 115° C., and the reaction was allowed to proceed for 6 h while removing the water produced by the reaction from the system.

The reaction liquid temperature was then lowered to room temperature, followed by washing twice with 120 g of 5% aqueous sodium hydroxide and then three times with 120 g of purified water. The organic phase was separated from the washed reaction liquid, and the solvent was removed under reduced pressure to obtain polyether monomethacrylate A-11. The resulting polyether mono(meth)acrylates are shown in Table 1.

TABLE 1

| | | Polyether | | Poly- | Number- | Number | | average | |
|---|---|---|---|---|---|---|---|---|---|
| | | com- | | ether | average | of | | addition | |
| | Mole- | position | | Starting | mole- | carbon | | mole | |
| | cular | ratio | | sub- | cular | atoms | | numbers | |
| | structure | EO | PC | stance | weight | R² | R³ | m1 | n1 |
| A-1 | Mono- | 80 | 20 | 1- | 6000 | 2 or 3 | 6 | 108 | 20 |
| A-2 | acrylate | 95 | 5 | Hexanol | 5000 | 2 or 3 | 6 | 106 | 4 |
| A-3 | | 80 | 20 | | 5000 | 2 or 3 | 6 | 89 | 17 |
| A-4 | | 80 | 20 | 1- | 2000 | 2 or 3 | 4 | 35 | 7 |
| A-5 | | 80 | 20 | Butanol | 1000 | 2 or 3 | 4 | 17 | 3 |
| A-6 | | 80 | 20 | | 600 | 2 or 3 | 4 | 10 | 2 |
| A-7 | | 80 | 20 | | 400 | 2 or 3 | 4 | 6 | 1 |
| A-8 | | 90 | 10 | | 1000 | 2 or 3 | 4 | 19 | 2 |
| A-9 | | 50 | 50 | | 1000 | 2 or 3 | 4 | 11 | 8 |
| A-10 | Mono- | 50 | 50 | | 600 | 2 or 3 | 4 | 6 | 5 |
| A-11 | meth- | 50 | 50 | | 400 | 2 or 3 | 4 | 4 | 3 |
| | acrylate | | | | | | | | |

Polyether composition ratios indicate mole fractions. EO represents ethylene oxide, and PO represents propylene oxide.

### <Synthesis of Polymerizable Monomers: Ionic Compounds>

Next, ionic compounds forming the structure represented by formula (2) were synthesized. Examples of the synthesis of an ionic compounds capable of forming the structure represented by formula (2) are shown below.

### (Synthesis of Ionic Compound C-1)

A total of 15.0 g (0.06 mol) of 3-sulfopropyl methacrylate potassium salt (manufactured by Tokyo Chemical Industry Co., Ltd.) was suspended in 100 mL of tetrahydrofuran and 0.5 mL of N,N-dimethylformamide, followed by the addition of 20 mL (0.28 mol) of thionyl chloride and stirring for 3 h. This mixture was concentrated under reduced pressure, and the residue was dissolved in dichloromethane. After washing with 50 mL of purified water and 50 mL of brine, concentration under reduced pressure was performed again to obtain a pale yellow liquid. The resulting pale yellow liquid was added to a solution obtained by dissolving 9.20 g (0.06 mol) of trifluoromethanesulfonylamide (manufactured by Tokyo Chemical Industry Co., Ltd.) and 27.3 mL (0.20 mol) of triethylamine (manufactured by Kishida Chemical Co., Ltd.) in 50 mL of tetrahydrofuran. The components were stirred for 2 h, and then the reaction liquid was concentrated under reduced pressure. The resulting residue was dissolved in dichloromethane and washed with 150 mL of purified water. The organic layer was dried under reduced pressure to obtain a yellow liquid. The resulting yellow liquid was dissolved in 300 mL of tetrahydrofuran, and 1.43 g (0.18 mol) of lithium hydride (manufactured by Fujifilm Wako Pure Chemical Industries, Ltd.) was added and stirred overnight. Unreacted lithium hydride was removed by filtration through Celite, and the filtrate was dried under reduced pressure to obtain ionic compound C-1.

### (Synthesis of Ionic Compound C-2)

Ionic compound C-2 was obtained in the same manner as ionic compound C-1, except that the starting material was changed to 15.9 g (0.06 mol) of 3-sulfopropyl acrylate potassium salt (manufactured by Tokyo Chemical Industry Co., Ltd.).

### (Synthesis of Ionic Compound C-3)

A total of 7.78 g (0.07 mol) of hydroxymethanesulfonate (manufactured by Atomax Chemical Products Co., Ltd.) was dissolved in 50 mL of tetrahydrofuran, and 5.17 g (0.06 mol) of methacrylic acid (manufactured by Kishida Chemical Co., Ltd.) and molecular sieves were added, followed by stirring at 80° C. for 3 h. The filtrate obtained by filtering through Celite was dried under reduced pressure and then redissolved in 50 mL of THF. A total of 2.41 g (0.06 mol) of potassium hydride (manufactured by Merck & Co., Inc.) was added and stirring was performed at room temperature for 2 h. The white solid obtained after drying under reduced pressure was used as the starting material to obtain ionic compound C-3 in the same manner as for ionic compound C-1.

### (Synthesis of Ionic Compound C-4)

A total of 12.9 g of 1-heptanesulfonyl chloride, 7-hydroxy (manufactured by Hong Kong Chemhere Co, Ltd.) and 6.07 g (0.06 mol) of triethylamine (manufactured by Kishida Chemical Co., Ltd.) were added to 80 mL of dichloromethane and stirred at room temperature. After washing with 100 mL of purified water, the organic phase was dried under reduced pressure to obtain an oily liquid. A total of 5.64 g (0.06 mol) of sodium acrylate (manufactured by Merck & Co., Inc.) was dissolved in 50 mL of ethanol, and the oily liquid obtained earlier and 0.022 g (0.20 mmol) of hydroquinone (manufactured by Kanto Chemical Co., Ltd.) were added to the solution. The components were stirred at 70° C. for 5 h. The pale yellow solid obtained after drying under reduced pressure was used as the starting material to obtain ionic compound C-4 in the same manner as for ionic compound C-2.

### (Synthesis of Ionic Compound C-5)

Ionic compound C-5 was obtained in the same manner as ionic compound C-2, except that the trifluoromethanesulfonamide (manufactured by Tokyo Chemical Industry Co., Ltd.) was replaced with 5.94 g (0.06 mol) of sulfamoylfluoride (manufactured by Atomax Chemical Products Co., Ltd.) as the reactant.

### (Synthesis of Ionic Compound C-6)

Ionic compound C-6 was obtained in the same manner as ionic compound C-1, except that the trifluoromethanesulfonamide (manufactured by Tokyo Chemical Industry Co., Ltd.) was replaced with 18.0 g (0.06 mol) of nonafluorobutane-1-sulfonamide (manufactured by Enamine Co., Ltd.) as the reactant.

### (Synthesis of Ionic Compound C-7)

Ionic compound C-7 was obtained in the same manner as ionic compound C-5, except that lithium hydride was changed to 4.32 g (0.18 mol) of sodium hydride (manufactured by Tokyo Chemical Industry Co., Ltd.).

### (Synthesis of Ionic Compound C-8)

Ionic compound C-8 was obtained in the same manner as ionic compound C-6, except that lithium hydride was changed to 7.22 g (0.18 mol) of potassium hydride (manufactured by Merck & Co., Inc.) as the reactant.

The chemical structures of the resulting reactive ionic compounds are shown in formulas C-1 to C-8.

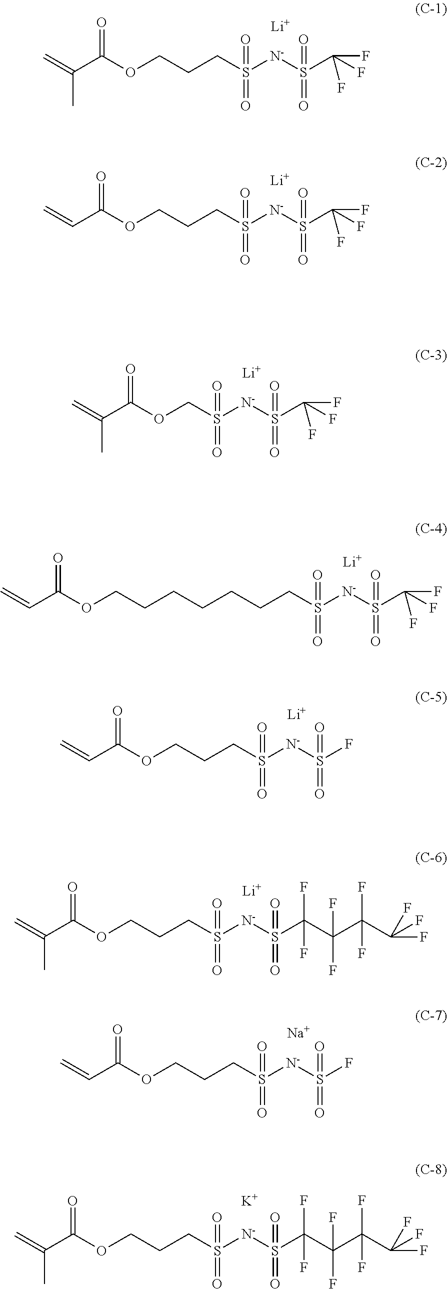

### <Synthesis of Acrylsulfonylimide Conducting Agent>

### (Acrylsulfonylimide Conducting Agent IP-1)

A total of 50.0 parts by mass of M-230G (product name, chemical structure: monofunctional methoxypolyalkylene glycol methacrylate, manufactured by Shin-Nakamura Chemical Co., Ltd.) as the polymerizable monomer that provides structural unit (1), 10.0 parts by mass of C-3 as the polymerizable monomer that provides structural unit (2), 1.0 L of dried ethanol, and 1.0 part by mass of 2,2′-azobisisobutyronitrile (manufactured by Tokyo Chemical Industry Co., Ltd.) were added to a four-neck separable flask equipped with a stirrer, a condenser, a thermometer, and a nitrogen introduction tube, and stirred until the system became homogeneous. The temperature in the reaction system was raised to 70° C. under continuous stirring, and the reaction was carried out for 8 h in a nitrogen introduction and reflux state. Ethanol was then distilled off to obtain the copolymer, acrylsulfonylimide conducting agent IP-1.

### (Acrylsulfonylimide Conducting Agents IP-2 to IP-27 and IPH-1 to IPH-3)

Acrylsulfonylimide conducting agents IP-2 to IP-27 and IPH-1 to IPH-3 were obtained in the same manner as in the synthesis of IP-1, except that the polymerizable monomers and amounts thereof were changed as shown in Table 2.

TABLE 2

| Acryl- | Polyether | | | | Number- |
|---|---|---|---|---|---|
| sulfonylimide | mono(meth)acrylate | | Reactive ion | | average |
| conducting | | parts by | | parts | molecular |
| agent | No. | mass | No. | by mass | weight |
| IP-1 | M-230G | 50 | C-3 | 10 | 14000 |
| IP-2 | A-1 | 50 | C-3 | 10 | 24000 |
| IP-3 | A-2 | 70 | C-1 | 20 | 20000 |
| IP-4 | AM-130G | 70 | C-1 | 20 | 14300 |
| IP-5 | A-3 | 90 | C-1 | 20 | 20000 |
| IP-6 | A-4 | 90 | C-1 | 20 | 16000 |
| IP-7 | A-5 | 90 | C-1 | 20 | 14000 |
| IP-8 | A-6 | 90 | C-1 | 20 | 13200 |
| IP-9 | A-7 | 90 | C-1 | 20 | 12000 |
| IP-10 | A-4 | 95 | C-4 | 10 | 16000 |
| IP-11 | AM-230G | 95 | C-2 | 10 | 14000 |
| IP-12 | A-8 | 95 | C-2 | 10 | 14000 |
| IP-13 | A-5 | 95 | C-2 | 10 | 14000 |
| IP-14 | A-9 | 95 | C-2 | 10 | 14000 |
| IP-15 | A-5 | 95 | C-4 | 10 | 14000 |
| IP-16 | AM-90G | 98 | C-6 | 30 | 12000 |
| IP-17 | AM-130G | 98 | C-6 | 30 | 14300 |
| IP-18 | A-5 | 98 | C-6 | 30 | 14000 |
| IP-19 | M-450G | 98 | C-6 | 30 | 16000 |
| IP-20 | A-10 | 70 | C-1 | 5 | 13200 |
| IP-21 | A-10 | 70 | C-3 | 5 | 13200 |
| IP-22 | A-10 | 70 | C-5 | 5 | 13200 |
| IP-23 | A-10 | 70 | C-6 | 5 | 13200 |
| IP-24 | A-10 | 70 | C-7 | 5 | 13200 |
| IP-25 | A-10 | 70 | C-8 | 5 | 13200 |
| IP-26 | A-11 | 98 | C-3 | 50 | 12000 |
| IP-27 | A-9 | 98 | C-3 | 50 | 14000 |
| IPH-1 | M-230G | 100 | — | — | 14000 |
| IPH-2 | — | — | C-1 | 100 | 350 |
| IPH-3 | Non-ether | 50 | C-1 | 20 | 10000 |
| | structure A-A | | | | |

The materials indicated in the table are listed below:
M-230G (product name, chemical structure: monofunctional methoxypolyalkylene glycol methacrylate, manufactured by Shin-Nakamura Chemical Co., Ltd.)
AM-130G (product name, chemical structure: monofunctional methoxypolyalkylene glycol acrylate, manufactured by Shin-Nakamura Chemical Co., Ltd.)
AM-230G (product name, chemical structure: monofunctional methoxypolyalkylene glycol acrylate, manufactured by Shin-Nakamura Chemical Co., Ltd.)
AM-90G (product name, chemical structure: monofunctional methoxypolyalkylene glycol acrylate, manufactured by Shin-Nakamura Chemical Co., Ltd.)
M-450G (product name, chemical structure: monofunctional methoxypolyalkylene glycol methacrylate, manufactured by Shin-Nakamura Chemical Co., Ltd.)
M-40G (product name, chemical structure: monofunctional methoxypolyalkylene glycol methacrylate, manufactured by Shin-Nakamura Chemical Co., Ltd.)
Non-ether structure A-A (product name: IBOA-B, chemical structure: monofunctional isobornyl acrylate (structure shown in formula (4) below), manufactured by Daicel Corporation)

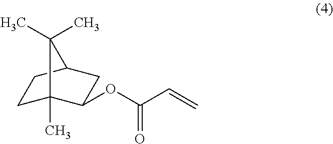

The polymerized structures of the materials used are as follows:
M-230G (methoxypolyethylene glycol methacrylate, in formula (1-1), R¹: methyl group, R²: ethylene group —(CH₂)₂—, R³: methyl group, m1: 23, n1: 0, Mn: 1000)
AM-130G (methoxypolyethylene glycol #600 acrylate, in formula (1-1), R¹: hydrogen atom, R²: ethylene group, R³: methyl group, m1: 13, n1: 0, Mn: 650)
AM-230G (methoxypolyethylene glycol #1000 acrylate, in formula (1-1), R¹: hydrogen atom, R²: ethylene group, R³: methyl group, m1: 23, n1: 0, Mn: 1000)
AM-90G (methoxypolyethylene glycol #400 acrylate (R¹: hydrogen atom, R²: ethylene group, R³: methyl group, m1: 9, n1: 0, Mn: 500 in formula (1-1))
M-450G (methoxypolyethylene glycol methacrylate (R¹: methyl group, R²: ethylene group, R³: methyl group, m1: 45, n1: 0, Mn: 2000 in formula (1-1))
M-40G (methoxypolyethylene glycol methacrylate (R¹: methyl group, R²: ethylene group, R³: methyl group, m1: 3, n1: 0, Mn: 300 in formula (1-1))

### <Synthesis of Isocyanate-Terminated Prepolymer>

An isocyanate compound for forming a urethane resin was synthesized.

### (Synthesis of Isocyanate-Terminated Prepolymer B-1)

In a reaction vessel under a nitrogen atmosphere, 100.0 parts by mass of polypropylene glycol-based polyol (product name: Exenol 230; manufactured by Asahi Glass Co., Ltd.) was slowly added dropwise to 33.8 parts by mass of polymeric MDI (product name: Millionate MR; manufactured by Tosoh Corporation) while maintaining the temperature inside the reaction vessel at 65° C.

After the addition was completed, a reaction was carried out at 65° C. for 2 h, and then 57.3 parts by mass of methyl ethyl ketone was added. The resulting reaction mixture was cooled to room temperature to obtain isocyanate-terminated urethane prepolymer B-1 with an isocyanate group content of 4.80% by weight.

### (Synthesis of Isocyanate-Terminated Prepolymer B-2)

In a reaction vessel under a nitrogen atmosphere, 8.8 parts by mass of polymeric MDI (product name: Millionate MT; manufactured by Tosoh Corporation) was dissolved in methyl ethyl ketone to a final solids content of 50%. Next, while maintaining the temperature inside the reaction vessel at 65° C., 100.0 parts by mass of olefin-based polyol (product name: Poly bd R-45HT; manufactured by Idemitsu Kosan Co., Ltd.) was gradually added dropwise to the reaction vessel.

After the addition was completed, a reaction was carried out at 65° C. for 2 h. The resulting reaction mixture was cooled to room temperature, yielding isocyanate-terminated prepolymer B-2 with a solids content of 50% and an isocyanate group content of 1.40% by weight.

### <<Preparation of Coating Material for Forming Surface Layer>>

### (Preparation of Coating Material E-1 for Forming Surface Layer)

The materials listed in Table 3 below were mixed and stirred as materials of the surface layer.

Next, methyl ethyl ketone was added to achieve a total solids ratio of 30% by mass, and mixing was performed using a sand mill. The viscosity was then adjusted to 10-13 cps with methyl ethyl ketone to prepare coating material E-1 for forming surface layer.

TABLE 3

| | Pars by |
|---|---|
| Material | mass |
| Polypropylene glycol-based polyol (product name: | 59.2 |
| Exenol 230; manufactured by Asahi Glass Co., Ltd.) | |
| Isocyanate-terminated prepolymer B-1 | 58.4 |
| Acrylsulfonylimide conducting agent IP-1 | 2.0 |
| Silica (product name: AEROSIL 200; manufactured by | 15.0 |
| Nippon Aerosil Co., Ltd.) | |
| Urethane resin particles (product name: Art Pearl | 10.0 |
| C-400; manufactured by Negami Chemical Industrial | |
| Co., Ltd.) | |

### (Preparation of Coating Material E′-1 for Forming Surface Layer)

The materials listed in Table 4 below were mixed and stirred as materials of the surface layer. Coating material E′-1 for forming surface layer was obtained in the same manner as coating material E-1.

TABLE 4

| | Pars by |
|---|---|
| Material | mass |
| Olefin-based polyol (product name: Poly bd R-45HT; | 28.0 |
| manufactured by Idemitsu Kosan Co., Ltd.) | |
| Isocyanate-terminated prepolymer B-2 | 72.0 |
| Acrylsulfonylimide conducting agent IP-1 | 2.0 |
| Silica (product name: AEROSIL 200; manufactured | 15.0 |
| by Nippon Aerosil Co., Ltd.) | |
| Urethane resin particles (product name: Art Pearl | 10.0 |
| C-400; manufactured by Negami Chemical Industrial | |
| Co., Ltd.) | |

### (Preparation of Coating Materials E-2 to E-27 and EH-1 to EH-4 for Forming Surface Layer)

Coating materials E-2 to E-27 and EH-1 to EH-4 for forming surface layer were prepared in the same manner as coating material E-1 for forming surface layer, except that the acrylsulfonylimide conducting agent was changed as shown in Table 5 below.

TABLE 5

| | | | | | Acryl- | | | |
|---|---|---|---|---|---|---|---|---|
| Coating | Resin for | | | | sulfonyl- | | | |
| material | forming surface layer | | | | imide | | | |
| for | | | Curing | | conducting | | Ion | |
| forming | Polyol | | agent | | agent | | component | |
| surface | | Parts | | Parts | | Parts | | Parts |
| layer | | by | | by | | by | | by |
| No. | No. | mass | No. | mass | No. | mass | No. | mass |
| E-1 | Exenol | 59.2 | B-1 | 58.4 | IP-1 | 2.00 | — | — |
| E-2 | 230 | | | | IP-2 | 2.00 | — | — |
| E-3 | | | | | IP-3 | 1.75 | — | — |
| E-4 | | | | | IP-4 | 1.75 | — | — |
| E-5 | | | | | IP-5 | 2.00 | — | — |
| E-6 | | | | | IP-6 | 2.00 | — | — |
| E-7 | | | | | IP-7 | 2.00 | — | — |
| E-8 | | | | | IP-8 | 2.00 | — | — |
| E-9 | | | | | IP-9 | 2.00 | — | — |
| E-10 | | | | | IP-10 | 4.25 | — | — |
| E-11 | | | | | IP-11 | 3.75 | — | — |
| E-12 | | | | | IP-12 | 3.75 | — | — |
| E-13 | | | | | IP-13 | 3.75 | — | — |
| E-14 | | | | | IP-14 | 3.75 | — | — |
| E-15 | | | | | IP-15 | 4.25 | — | — |
| E-16 | | | | | IP-16 | 1.75 | — | — |
| E-17 | | | | | IP-17 | 1.75 | — | — |
| E-18 | | | | | IP-18 | 1.75 | — | — |
| E-19 | | | | | IP-19 | 1.75 | — | — |
| E-20 | | | | | IP-20 | 5.00 | — | — |
| E-21 | | | | | IP-21 | 5.00 | — | — |
| E-22 | | | | | IP-22 | 5.00 | — | — |
| E-23 | | | | | IP-23 | 5.00 | — | — |
| E-24 | | | | | IP-24 | 5.00 | — | — |
| E-25 | | | | | IP-25 | 6.00 | — | — |
| E-26 | | | | | IP-26 | 1.00 | — | — |
| E-27 | | | | | IP-27 | 1.00 | — | — |
| E′-1 | Poly | 28.0 | B-2 | 72.0 | IP-1 | 2.00 | — | — |
| | bd R- | | | | | | | |
| | 45HT | | | | | | | |
| EH-1 | Exenol | 59.2 | B-1 | 58.4 | — | — | Li•TSFI | 0.30 |
| EH-2 | 230 | | | | IPH-1 | 3.00 | Li•TSFI | 0.30 |
| EH-3 | | | | | IPH-2 | 0.40 | — | — |
| EH-4 | | | | | IPH-3 | 1.25 | — | — |

In Table 5, Li-TFSI stands for lithium bis(trifluoromethanesulfonyl)imide (the same applies below).

### <<Preparation of Conductive Roller>>

### <Preparation of Silicone Rubber Elastic Roller>

A conductive substrate was prepared by coating a primer (product name: DY35-051, manufactured by Dow Corning Toray Co., Ltd.) on a core made of SUS304 and having an outer diameter of 6 mm and a length of 264 mm and heating at 150° C. for 20 min. This conductive substrate was placed concentrically within a cylindrical mold with an inner diameter of 11.5 mm.

The elastic layer was prepared by mixing the materials listed in Table 6 below with Trimix (product name: TX-15, manufactured by Inoue Seisakusho Co., Ltd.) to form an addition-type silicone rubber composition and injecting this composition into a mold heated to 115° C. After injection, the material was heated and molded at 120° C. for 10 min, cooled to room temperature, and demolded to obtain elastic roller D′-1, which had a 2.71 mm thick intermediate layer formed around the outer periphery of the conductive substrate.

TABLE 6

| | Parts |
|---|---|
| Material | by mass |
| Liquid dimethylpolysiloxane having two or more silicon | 100.0 |
| atom-bonded alkenyl groups in a molecule (product name: | |
| SF3000E, viscosity 10,000 cP, vinyl group equivalent 0.05 | |
| mmol/g, manufactured by KCC Co., Ltd.) | |
| Platinum-based catalyst (product name: SIP6832.2, | 0.048 |
| manufactured by Gelest Co., Ltd.) | |
| Dimethylpolysiloxane having two or more silicon atom- | 0.5 |
| bonded hydrogen atoms in a molecule (product name: | |
| SP6000P, Si—H group equivalent 15.5 mmol/g, manufactured | |
| by KCC Co., Ltd.) | |
| Carbon black (product name: TOKABLACK #7360SB, | 6.0 |
| manufactured by Tokai Carbon Co., Ltd. | |

### <Preparation of NBR Rubber Elastic Roller>

The types and amounts of materials listed in Table 7 below were mixed in a pressure kneader to obtain kneaded rubber composition A.

TABLE 7

| | Parts by |
|---|---|
| Material | mass |
| NBR rubber (product name: Nipol DN219, | 100.0 |
| manufactured by Japan Zeon Co., Ltd.) | |
| Carbon black (product name: TOKABLACK #4300, | 40.0 |
| manufactured by Tokai Carbon Co., Ltd. | |
| Calcium carbonate (product name: Nanox #30, | 20.0 |
| manufacture by Maruo Calcium Co., Ltd.) | |
| Stearic acid (product name: Stearic Acid S, | 1.0 |
| manufactured by Kao Corp.) | |

Furthermore, 166.0 parts by mass of the kneaded rubber composition A was mixed with the types and amounts of materials listed in Table 8 below with an open roll to prepare an unvulcanized rubber composition.

TABLE 8

| | Parts by |
|---|---|
| Material | mass |
| Sulfur (product name: Sulfax 200S, manufactured by | 1.2 |
| Tsurumi Chemical Industry Co., Ltd.) | |
| Tetrabenzylthiuram disulfide (product name: TBZTD, | 4.5 |
| manufactured by Sanshin Chemical Industry Co., Ltd.) | |

Next, a crosshead extruder equipped with a conductive mandrel feed mechanism and an unvulcanized rubber roller discharge mechanism was prepared. A die with an inner diameter of 16.5 mm was attached to the crosshead, and the crosshead extruder was heated to 80° C. The conductive mandrel feed speed was adjusted to 60 mm/sec. Under these conditions, an unvulcanized rubber composition was fed from the extruder and coated as an unvulcanized rubber layer onto the circumferential surface of the conductive mandrel prepared above in the crosshead, yielding an unvulcanized rubber roller. The unvulcanized rubber roller was then placed in a hot-air vulcanization furnace at 170° C. and heated for 60 min to obtain an unpolished conductive roller. The edges of the NBR rubber elastic layer obtained by the vulcanization of the unvulcanized rubber layer were then cut and removed, and the surface of the NBR rubber elastic layer was polished with a grinding wheel. This resulted in the production of elastic roller D′-2 with a diameter of 8.4 mm at positions 90 mm from the center to both ends and a central diameter of 8.5 mm.

### Example 1

First, the previously prepared elastic roller D′-1 was immersed in the above-mentioned coating material E-1 for forming a surface layer to form a coating film of the coating material on the surface of the elastic layer, and the coating film was air-dried. Further, a heat treatment at 150° C. for 1 h provided a surface layer with a thickness of approximately 15 μm on the outer periphery of the elastic layer, thereby producing a conductive roller. A conductive roller D-1 for use in Example 1 was thus obtained.

### Examples 2 to 29 and Comparative Examples 1 to 5

A coating film was formed on the surface of the elastic layer of elastic roller D′-1 in the same manner as in Example 1, except that the coating material used for forming a surface layer was the one shown in Table 9. The coating film was then dried and then heat-treated at 150° C. for 1 h. Conductive rollers D-2 to D-29 of Examples 2 to 29 and conductive rollers DH-1 to DH-5 of Comparative Examples 1 to 4 were thus obtained.

### Example 30 and Comparative Example 6

The conductive roller D-30 of Example 30 and the conductive roller DH-6 of Comparative Example 6 were obtained in the same manner as in Examples 2 to 29 and Comparative Examples 1 to 5, except that the coating materials for forming a surface layer that are shown in Table 9 were used and elastic roller D′-2 was used.

### <Confirmation of Product Structure>

The resins obtained in these synthesis examples were analyzed using a pyrolysis apparatus (product name: Pyrofoil Sampler JPS-700, manufactured by Japan Analytical Industry Co., Ltd.) and a GC/MS apparatus (product name: Focus GC/ISQ, manufactured by Thermo Fisher Scientific, Inc.) at a pyrolysis temperature of 590° C. and helium as a carrier gas. The resulting fragment peaks confirmed that the resin had the structures represented by structural formulas (1) and (2).

### <<Evaluation of Conductive Rollers>>

Data on the conductive rollers according to the Examples and Comparative Examples are shown in Table 9 below.

TABLE 9

| | | | | Coating | Acryl- | |
|---|---|---|---|---|---|---|
| | | | | material | sulfonyl- | |
| | | | | for | imide | |
| | | Con- | | forming | con- | |
| | Com- | ductive | Elastic | surface | ducting | Ion |
| Ex- | parative | roller | roller | layer | agent | com- |
| ample | Example | No. | No. | No. | No. | ponent |
| 1 | — | D-1 | D′-1 | E-1 | IP-1 | — |
| 2 | — | D-2 | D′-1 | E-2 | IP-2 | — |
| 3 | — | D-3 | D′-1 | E-3 | IP-3 | — |
| 4 | — | D-4 | D′-1 | E-4 | IP-4 | — |
| 5 | — | D-5 | D′-1 | E-5 | IP-5 | — |
| 6 | — | D-6 | D′-1 | E-6 | IP-6 | — |
| 7 | — | D-7 | D′-1 | E-7 | IP-7 | — |
| 8 | — | D-8 | D′-1 | E-8 | IP-8 | — |
| 9 | — | D-9 | D′-1 | E-9 | IP-9 | — |
| 10 | — | D-10 | D′-1 | E-10 | IP-10 | — |
| 11 | — | D-11 | D′-1 | E-11 | IP-11 | — |
| 12 | — | D-12 | D′-1 | E-12 | IP-12 | — |
| 13 | — | D-13 | D′-1 | E-13 | IP-13 | — |
| 14 | — | D-14 | D′-1 | E-14 | IP-14 | — |
| 15 | — | D-15 | D′-1 | E-15 | IP-15 | — |
| 16 | — | D-16 | D′-1 | E-16 | IP-16 | — |
| 17 | — | D-17 | D′-1 | E-17 | IP-17 | — |
| 18 | — | D-18 | D′-1 | E-18 | IP-18 | — |
| 19 | — | D-19 | D′-1 | E-19 | IP-19 | — |
| 20 | — | D-20 | D′-1 | E-20 | IP-20 | — |
| 21 | — | D-21 | D′-1 | E-21 | IP-21 | — |
| 22 | — | D-22 | D′-1 | E-22 | IP-22 | — |
| 23 | — | D-23 | D′-1 | E-23 | IP-23 | — |
| 24 | — | D-24 | D′-1 | E-24 | IP-24 | — |
| 25 | — | D-25 | D′-1 | E-25 | IP-25 | — |
| 26 | — | D-26 | D′-1 | E-26 | IP-26 | — |
| 27 | — | D-27 | D′-1 | E-27 | IP-27 | — |
| 28 | — | D-28 | D′-1 | E′-1 | IP-1 | — |
| 29 | — | D-29 | D′-2 | E-1 | IP-1 | — |
| 30 | — | D-30 | D′-2 | E-25 | IP-25 | — |
| — | 1 | DH-1 | D′-1 | EH-1 | — | Li•TSFI |
| — | 2 | DH-2 | D′-1 | EH-2 | IPH-1 | Li•TSFI |
| — | 3 | DH-3 | D′-1 | EH-3 | IPH-2 | — |
| — | 4 | DH-4 | D′-1 | EH-4 | IPH-3 | — |
| | 5 | DH-5 | D′-1 | E′-1 | IP-1 | — |
| — | 6 | DH-6 | D′-2 | EH-2 | IPH-1 | Li•TSFI |

The conductive rollers obtained according to the Examples were evaluated for the following items. The results are shown in Table 10.

### <Evaluation of Roller Resistance Fluctuation>

Roller resistance measurements were performed using conductive rollers that had been allowed to stand in a 0° C. environment for at least 6 h.

### [Measurement of Initial Roller Resistance]

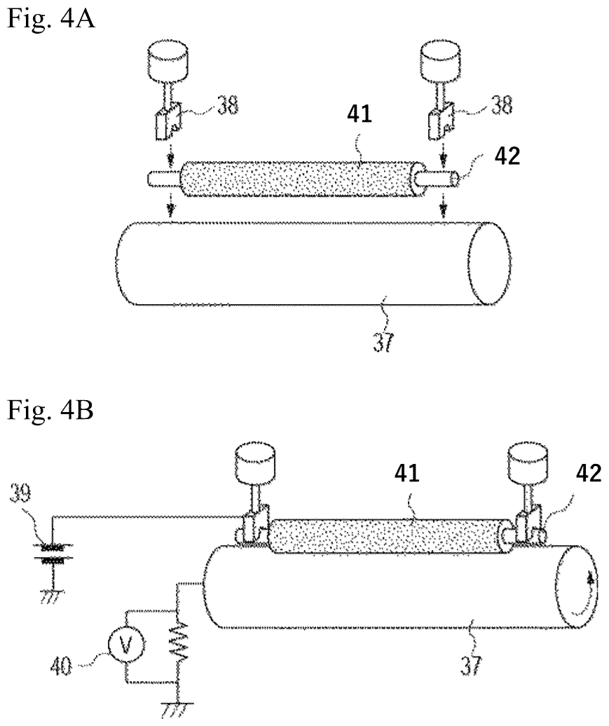

FIGS. 4A and 4B show schematic diagrams of a roller resistance fluctuation evaluation jig according to the present disclosure. As shown in FIG. 4A, in a 0° C. environment, a cylindrical metal 37 having diameter a of 24 mm was rotated at a surface speed of 50 mm/sec while a 4.9 N load was applied to both ends of a conductive mandrel 42 through a conductive bearings 38, causing a conductive roller 41 to follow. Next, as shown in FIG. 4B, a voltage of 50 V was applied from a high-voltage power supply 39, and the potential difference across a resistor with a known electrical resistance (two or more orders of magnitude lower than the electrical resistance of the conductive roller) placed between the cylindrical metal 37 and ground was measured. A voltmeter 40 (189 TRUE RMS MULTIMETER, manufactured by FLUKE Co, Ltd.) was used to measure the potential difference. The current flowing in the cylindrical metal through the conductive roller 41 was calculated from the measured potential difference and the electrical resistance of the resistor. The electrical resistance of the conductive roller 41 was calculated by dividing the applied voltage of 50 V by the resulting current.

Here, the potential difference was measured by performing 3-sec sampling starting 2 sec after the voltage was applied, and the value calculated from the average value was used as the initial roller resistance.

### [Measurement of Roller Resistance After Evaluation]

After performing the ghost evaluation described below, the roller was immediately ejected and the roller resistance after energization was measured as-is in a 0° C. environment.

### [Electrical Degradation]

The value obtained by dividing the roller resistance after evaluation by the initial roller resistance (roller resistance after evaluation/initial roller resistance) was used as an index of electrical degradation.

### <Evaluation of Ghosting>

Next, the conductive roller for which the initial roller resistance had been measured as described above was allowed to stand in a 0° C. environment for at least 6 h, and then the following evaluation was performed.

A laser printer (product name: LBP7700C; manufactured by Canon Inc.) with the configuration shown in FIG. 3 was placed in a 0° C. environment, and the conductive roller serving as the electrophotographic member of this example was loaded as a developing roller to evaluate ghost images.

Specifically, using black toner, a 15-mm square solid black image was printed as an image pattern at the leading edge of one sheet, and then a full-page halftone image was printed. The periodic density unevenness of the developing roller (as a toner carrying member) that appeared in the halftone portion was then visually evaluated, and ghosting was evaluated according to the following criteria.

### [Evaluation of Ghosting in a 0° C. Environment]

A: No ghosting was observed.
B: Very slight ghosting was observed.
C: Significant ghosting was observed.

TABLE 10

| | | | Acryl- | | | | | | | |
|---|---|---|---|---|---|---|---|---|---|---|
| | | | sulfonyl- | | | | | | | |
| | | | imide | | Im- | | Initial | Roller | | |
| | Com- | Con- | con- | | preg- | | roller | resistance | | |
| | parative | ductive | ducting | Non- | nation | | resis- | after | Electrical | |
| Ex- | Ex- | roller | agent | reactive | treat- | Binder | tance | energization | de- | |
| ample | ample | No. | No. | ion | ment | resin | (Ω) | (Ω) | gradation | Ghost |
| 1 | — | D-1 | IP-1 | — | — | Ether | 5.4E+05 | 6.9E+05 | 1.28 | A |
| 2 | — | D-2 | IP-2 | — | — | group- | 3.6E+06 | 4.1E+06 | 1.15 | A |
| 3 | — | D-3 | IP-3 | — | — | containing | 4.8E+06 | 5.6E+06 | 1.17 | A |
| 4 | — | D-4 | IP-4 | — | — | urethane | 4.4E+06 | 5.1E+06 | 1.15 | A |
| 5 | — | D-5 | IP-5 | — | — | resin | 7.4E+05 | 1.0E+06 | 1.38 | B |
| 6 | — | D-6 | IP-6 | — | — | | 2.1E+07 | 2.7E+07 | 1.32 | B |
| 7 | — | D-7 | IP-7 | — | — | | 2.0E+07 | 2.5E+07 | 1.26 | A |
| 8 | — | D-8 | IP-8 | — | — | | 5.3E+07 | 5.8E+07 | 1.09 | A |
| 9 | — | D-9 | IP-9 | — | — | | 5.3E+07 | 5.9E+07 | 1.10 | A |
| 10 | — | D-10 | IP-10 | — | — | | 1.9E+07 | 2.0E+07 | 1.09 | A |
| 11 | — | D-11 | IP-11 | — | — | | 1.1E+06 | 1.2E+06 | 1.08 | A |
| 12 | — | D-12 | IP-12 | — | — | | 1.3E+07 | 1.7E+07 | 1.24 | A |
| 13 | — | D-13 | IP-13 | — | — | | 1.2E+07 | 1.5E+07 | 1.21 | A |
| 14 | — | D-14 | IP-14 | — | — | | 6.3E+07 | 6.8E+07 | 1.08 | A |
| 15 | — | D-15 | IP-15 | — | — | | 2.8E+06 | 3.1E+06 | 1.11 | A |
| 16 | — | D-16 | IP-16 | — | — | | 1.8E+06 | 2.1E+06 | 1.19 | A |
| 17 | — | D-17 | IP-17 | — | — | | 2.5E+06 | 3.1E+06 | 1.23 | A |
| 18 | — | D-18 | IP-18 | — | — | | 1.3E+06 | 1.7E+06 | 1.30 | A |
| 19 | — | D-19 | IP-19 | — | — | | 1.6E+06 | 2.0E+06 | 1.25 | A |
| 20 | — | D-20 | IP-20 | — | — | | 2.7E+06 | 3.4E+06 | 1.25 | A |
| 21 | — | D-21 | IP-21 | — | — | | 1.9E+06 | 2.5E+06 | 1.27 | A |
| 22 | — | D-22 | IP-22 | — | — | | 2.4E+06 | 3.0E+06 | 1.24 | A |
| 23 | — | D-23 | IP-23 | — | — | | 4.7E+06 | 5.7E+06 | 1.20 | A |
| 24 | — | D-24 | IP-24 | — | — | | 1.7E+06 | 2.5E+06 | 1.45 | B |
| 25 | — | D-25 | IP-25 | — | — | | 4.6E+06 | 6.9E+06 | 1.49 | B |
| 26 | — | D-26 | IP-26 | — | — | | 1.0E+06 | 1.3E+06 | 1.22 | A |
| 27 | — | D-27 | IP-27 | — | — | | 1.2E+06 | 1.5E+06 | 1.31 | B |
| 28 | — | D-28 | IP-1 | — | — | Ether | 5.1E+08 | 7.8E+08 | 1.53 | B |
| | | | | | | group | | | | |
| | | | | | | non- | | | | |
| | | | | | | containing | | | | |
| | | | | | | urethane | | | | |
| | | | | | | resin | | | | |
| — | 1 | DH-1 | — | Li•TSFI | — | Ether group- | 4.6E+09 | 4.0E+10 | 8.71 | C |
| — | 2 | DH-2 | IPH-1 | Li•TSFI | — | containing | 6.5E+09 | 3.0E+10 | 4.54 | C |
| — | 3 | DH-3 | IPH-2 | — | — | urethane | 6.3E+09 | 2.2E+10 | 3.42 | C |
| — | 4 | DH-4 | IPH-3 | — | — | resin | 1.2E+09 | 3.6E+09 | 2.98 | C |
| | 5 | DH-5 | — | Li•TSFI | — | Ether group | 3.3E+10 | 5.2E+11 | 15.6 | C |
| | | | | | | non- | | | | |
| | | | | | | containing | | | | |
| | | | | | | urethane | | | | |
| | | | | | | resin | | | | |

In the table, “E+number” represents the exponential notation of the value. For example, “5.4E+05” represents “5.4×10⁵” (The same applies hereinafter).

### <Evaluation of Horizontal Streak Images>

Next, the electrophotographic members obtained in Examples 29 and 30 and Comparative Example 6 were evaluated for the roller resistance fluctuation evaluation described above, and the following items were evaluated using these members as charging rollers.

Changes in conductivity (increases in electrical resistance) due to the energization of the charging roller can cause fine, streak-like density variations (horizontal streaks) in halftone images. This is called a horizontal streak image. These horizontal streak images tend to occur more frequently as the conductivity of the charging roller changes, and tend to become more noticeable with extended use of the electrophotographic apparatus. The electrophotographic member of the present disclosure was incorporated as a charging roller into an electrophotographic apparatus, and the following evaluations were performed.

The conductive rollers obtained in Examples 29 and 30 and Comparative Example 6 were installed as charging rollers in an electrophotographic laser printer (product name: HPColor Laserjet Enterprise CP4515dn, manufactured by HP, Inc.) serving as an electrophotographic apparatus. A durability test was then conducted in which 4% print density images (images depicting horizontal lines 2 dots wide and 50 dots apart in the direction perpendicular to the rotational direction of the photosensitive member) were continuously output. After 24,000 sheets of continuous image output, a halftone image (image depicting horizontal lines 1 dot wide and 2 dots apart in the direction perpendicular to the rotational direction of the photosensitive member) was also output for image checking. The resulting images were visually observed and evaluated for fine streak-like density unevenness (horizontal streaks). The evaluation results are shown in Table 11.
A: No horizontal streaks at all.
B: Slight horizontal streaks only at the edges of the image.
C: Horizontal streaks occurred over approximately half of the image, making the streaks noticeable.

TABLE 11

| | | | Acryl- | | | Roller | | |
|---|---|---|---|---|---|---|---|---|
| | | | sulfonyl- | | Initial | resistance | | |
| | | | imide | Non- | roller | after | | |
| | Comparative | Conductive | conducting | reactive | resistance | energization | Electrical | Horizontal |
| Example | Example | roller No. | agent No. | ion | (Ω) | (Ω) | degradation | streak |
| 29 | — | D-29 | IP-1 | — | 3.3E+08 | 4.1E+08 | 1.23 | A |
| 30 | — | D-30 | IP-25 | — | 4.4E+08 | 6.8E+08 | 1.54 | B |
| — | 6 | DH-6 | IPH-1 | Li•TSFI | 1.1E+09 | 3.3E+09 | 3.01 | C |

### <Discussion of Evaluation Results>

The electrophotographic members prepared in Examples 1 to 30 contained compounds having structures represented by formulas (1) and (2) according to the present disclosure in the surface layer serving as the conductive layer according to the present disclosure. This resulted in a small increase in resistance after image output in a 0° C. environment, and also good image quality.

In contrast, the electrophotographic members of Comparative Examples 1 to 6, which did not contain compounds having structures represented by formulas (1) and (2) according to the present disclosure, showed a large increase in resistance after image output in the above environment, resulting in significant adverse effects in image evaluation.

### <<Preparation of Blade Member>>

### Example 31

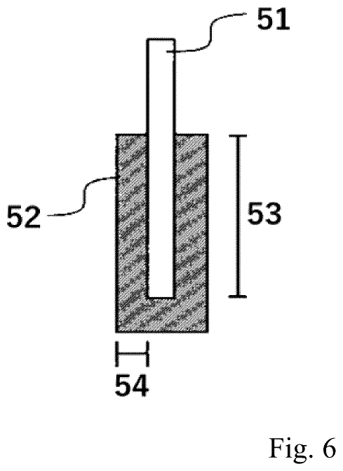

FIG. 6 shows a cross-sectional view of the electrophotographic member prepared in this example. A 0.08 mm thick SUS sheet (manufactured by Nisshin Steel Co., Ltd.) was press-cut to a length of 200 mm and a width of 23 mm to form the substrate 51. The cut SUS sheet was then immersed in the coating material E-1 for forming a surface layer so that the length 53 from the longitudinal end of the cut SUS sheet was 1.5 mm, thereby forming a coating film of the coating material. The coating film was then dried. Further, by performing a heat treatment at a temperature of 140° C. for 1 h, a resin layer 52 having a film thickness 54 of 10 μm was provided on the surface of the longitudinal end of the SUS sheet, and a blade member (developing blade) as an electrophotographic member according to the present disclosure was prepared.

### Example 32

A blade member of Example 32 was prepared using the same procedures as in Example 31, except that the coating material for forming a surface layer was changed from E-1 to E-25.

### Comparative Example 7

A blade member for Comparative Example 7 was prepared using the same procedures as in Example 31, except that the coating material for forming a surface layer was changed from E-1 to EH-2.

### <<Evaluation of Blade Members>>

### <Evaluation of Electrical Resistance>

The electrical resistances of the blade members of Examples 31 and 32 and Comparative Example 7 were measured in the same manner as in the resistance measurement of the roller described above. However, the roller-shaped electrophotographic member 1 in FIG. 4A was replaced with the blade member shown in FIG. 6. Specifically, bearings 38 were placed in contact with both longitudinal ends of the substrate 51 of the blade member shown in FIG. 6, and a load of 1.0 N was applied to each end, so that the resin layer at the tip of the blade member was brought into contact perpendicular to the circumferential surface of the cylindrical metal 37.

Next, without rotating the cylindrical metal 37, a voltage of 50 V was applied from the high-voltage power supply 39, and the potential difference across a resistor with a known electrical resistance (two or more orders of magnitude lower than the electrical resistance of the electrophotographic member 1) placed between the cylindrical metal 37 and ground was measured. A voltmeter 40 (product name: 189 TRUE RMS MULTIMETER, manufactured by FLUKE Co., Ltd.) was used to measure this potential difference. The current flowing in the cylindrical metal 37 through the development blade was calculated from the measured potential difference and the electrical resistance of the resistor.

The electrical resistance of the electrophotographic member 1 was calculated by dividing the applied voltage of 50 V by the resulting current. Here, the potential difference was measured by performing 3-sec sampling starting 2 sec after the voltage was applied, and the value calculated from the average value was used as the initial roller resistance.

### <Evaluation of Regulation Defects>

The electrophotographic member to be evaluated was loaded as a development blade into a laser printer (product name: LBP7700C; manufactured by Canon Inc.) having the configuration shown in FIG. 3. The laser printer was placed in a 0° C. environment and allowed to stand for at least 2 h. After that, 100 black images with a print percentage of 1% were continuously printed. A solid white image was then printed onto a new sheet of copy paper. After printing these images, the condition of the toner coat on the developing member surface was observed, and the presence or absence of electrostatic toner aggregation (regulation defects) due to abnormal charging of the toner was visually observed. The observation results were evaluated according to the following criteria:
A: No regulation defects were present on the toner coat.
B: Regulation defects were present on the toner coat, but not visible in the image.
C: Regulation defects were visible in the image.

TABLE 12

| | | | | | | Roller | | |
|---|---|---|---|---|---|---|---|---|
| | | | Acryl- | | Initial | resistance | | |
| | Com- | | sulfonylimide | | roller | after | | |
| | parative | Development | conducting | Ion | resistance | energization | Electrical | Regulation |
| Example | Example | blade No. | agent No. | component | (Ω) | (Ω) | degradation | defect |
| 31 | — | D-31 | IP-1 | — | 2.1E+08 | 2.6E+08 | 1.25 | A |
| 32 | — | D-32 | IP-25 | — | 3.7E+08 | 6.2E+08 | 1.68 | B |
| — | 7 | DH-7 | IPH-1 | Li•TSFI | 1.1E+09 | 3.9E+09 | 3.52 | C |

### <Discussion of Evaluation Results>

In Examples 31 and 32, the surface layer serving as the conductive layer according to the present disclosure contained compounds having structures represented by formulas (1) and (2) according to the present disclosure. Therefore, no increase in resistance was observed in a 0° C. environment, and no regulation defects occurred. Meanwhile, in Comparative Example 7, an increase in resistance was observed, resulting in regulation defects. The regulation defects in a 0° C. environment are believed to have occurred as a result of the increased resistance of the developing blade, preventing the blade bias from reaching the specified value and resulting in uneven toner charging.

### <<Preparation of Toner Supply Roller>>

### Example 33

A core made of stainless steel (SUS304) and having a diameter of 5 mm was placed as a substrate in a mold. A urethane rubber composition obtained by mixing the following materials was poured into the cavity formed in the mold.
Conducting agent IP-1: 2.0 parts by mass
Polyol (product name: Kuraray Polyol C-3090; manufactured by Kuraray Co., Ltd.): 84.2 parts by mass
Polyol (product name: Kuraray Polyol F-2010; manufactured by Kuraray Co., Ltd.): 18.6 parts by mass
Isocyanate (product name: Cosmonate TM20; manufactured by Mitsui Chemicals, Inc.): 22.7 parts by mass
Silicone foam stabilizer (product name: SRX274C; manufactured by Dow Corning Toray Silicones Co., Ltd.): 1.0 part by mass
Amine catalyst (product name: TOYOCAT-ET; manufactured by Tosoh Corporation): 0.3 parts by mass
Amine catalyst (product name: TOYOCAT-L33; manufactured by Tosoh Corporation): 0.2 parts by mass
Water: 2.0 parts by mass

The mold was then heated to vulcanize and foam-cure the urethane rubber composition at 50° C. for 20 min. The resulting substrate with a polyurethane foam layer formed on the peripheral surface thereof was then demolded. In this way, a toner supply roller according to Example 31 was prepared, having a polyurethane foam layer with a diameter of 16.1 mm around the outer periphery of the substrate.

### Example 34

A toner supply roller according to Example 34 was prepared in the same manner as in Example 33, except that the conducting agent was changed from 2.0 parts by mass of IP-1 to 6.0 parts by mass of IP-25.

### Comparative Example 8

A toner supply roller according to Comparative Example 8 was prepared in the same manner as in Example 31, except that the conducting agent was changed from 2.0 parts by mass of IP-1 to 0.3 parts by mass of Li TFSI.

### <<Evaluation of Toner Supply Rollers>>

### <Measurement of Resistance>

The electrical resistance of the toner supply rollers according to Examples 33 and 34 and Comparative Example 8 was measured in the same manner as in the measurement of resistance of the conductive roller described above. However, a load of 2.5 N was applied to both ends of the substrate, and the roller rotation speed during measurement was 32 rpm.

### <Evaluation of Regulation Defects>

The toner supply rollers of Example 31 and Comparative Example 8 were loaded into a process cartridge for a laser printer (product name: LBP7700C, manufactured by Canon Inc.) having the configuration shown in FIG. 2. The process cartridge was then installed in the laser printer, placed in a 0° C. environment, and then allowed to stand for 6 h. Next, 100 black images with a print percentage of 1% were continuously printed. A solid white image was then printed on a new sheet of copy paper. After printing these images, the condition of the toner coat on the surface of the toner supply roller was observed, and the presence or absence of electrostatic toner aggregation (regulation defects) due to abnormal charging of the toner was visually observed. The observation results were evaluated according to the following criteria. Regulation defects can cause the occurrence of image defects, such as spotted unevenness in non-printed areas or toner lumps on the image.
A: No regulation defects were present on the toner coat.
B: Regulation defects were present on the toner coat, but not visible in the image.
C: Regulation defects were visible in the image.

TABLE 13

| | | | Acryl- | | | Roller | | |
|---|---|---|---|---|---|---|---|---|
| | | | sulfonylimide | | Initial | resistance | | |
| | Com- | Toner | conducting | Ion | roller | after | | |
| | parative | supply | agent | com- | resistance | energization | Electrical | Regulation |
| Example | Example | roller No. | No. | ponent | (Ω) | (Ω) | degradation | defect |
| 33 | — | D-33 | IP-1 | — | 6.1E+08 | 8.0E+08 | 1.31 | A |
| 34 | — | D-34 | IP-25 | — | 8.2E+08 | 1.4E+09 | 1.72 | B |
| — | 8 | DH-7 | IPH-1 | Li•TSFI | 7.8E+09 | 4.5E+10 | 5.74 | C |

### <Discussion of Evaluation Results>

In Examples 33 and 34, the surface layer serving as the conductive layer according to the present disclosure contained compounds having structures represented by formulas (1) and (2) according to the present disclosure. Therefore, no increase in resistance was observed in a 0° C. environment, and no regulation defects occurred. Meanwhile, in Comparative Example 8, an increase in resistance was observed, resulting in regulation defects. The regulation defects in a 0° C. environment are believed to have occurred because of the increased resistance of the toner supply roller, which resulted in toner being supplied without the toner on the developing roller being properly scraped off by the toner supply roller, causing an oversupply of toner.

According to at least one aspect of the present disclosure, it is possible to obtain an electrophotographic member that contributes to the stable formation of high-quality electrophotographic images even in low-temperature environments. According to at least one aspect of the present disclosure, it is possible to obtain an electrophotographic process cartridge that contributes to the stable formation of high-quality electrophotographic images. According to at least one aspect of the present disclosure, it is possible to obtain an electrophotographic image forming apparatus that can stably form high-quality electrophotographic images. According to at least one aspect of the present disclosure, it is possible to obtain a copolymer that contributes to effective ion dissociation.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

1. An electrophotographic member having a conductive substrate and a conductive layer on the substrate, wherein
the conductive layer comprises a compound having a structure represented by formula (1) and a structure represented by formula (2): 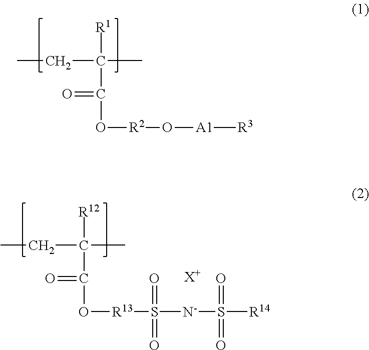
in formula (1),
R¹ represents a hydrogen atom or a methyl group,
R² represents a linear or branched alkylene group having 1 to 6 carbon atoms,
R³ represents an alkyl group having 1 to 6 carbon atoms,
A1 represents a linking group including a structure represented by (—CH₂CH₂—O—);
in formula (2),
R¹² represents a hydrogen atom or a methyl group,
R¹³ represents a linear or branched alkylene group having 1 to 7 carbon atoms,
R¹⁴ represents a fluorine atom or a linear or branched perfluoroalkyl group having 1 to 4 carbon atoms, and
X⁺ represents at least one selected from the group consisting of a lithium ion, a sodium ion, and a potassium ion.

2. The electrophotographic member according to claim 1, wherein A1 further includes a structure represented by (—CH₂CH(CH₃)—O—).

3. The electrophotographic member according to claim 1, wherein the structure represented by formula (1) is a structure represented by formula (1-1): 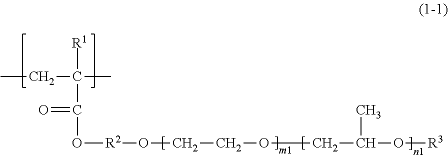
R² represents a linear or branched alkylene group having 1 to 6 carbon atoms,
R³ represents an alkyl group having 1 to 6 carbon atoms,
m1 and n1 are average addition mole numbers, where m1 is an integer of 1 or greater, and n1 is an integer of 0 or greater; wherein
arrangements of the structure represented by (—CH₂—CH₂—O—) and the structure represented by (—CH₂—CH(CH₃)—O—) may be a block copolymer or a random copolymer.

4. The electrophotographic member according to claim 1, wherein the conductive layer comprises a copolymer having the structure represented by formula (1) and the structure represented by formula (2).

5. The electrophotographic member according to claim 4, wherein a number-average molecular weight (Mn) of the copolymer is 500 to 100,000.

6. The electrophotographic member according to claim 4, wherein
the conductive layer comprises the copolymer and a binder resin, and
the binder resin contains an ether linkage in its molecular structure.

7. The electrophotographic member according to claim 6, wherein the binder resin is polyurethane.

8. An electrophotographic process cartridge, wherein
the electrophotographic process cartridge is configured to be detachably attached to a main body of an electrophotographic apparatus, and
the electrophotographic process cartridge comprises the electrophotographic member according to claim 1.

9. The electrophotographic process cartridge according to claim 8, comprising the electrophotographic member as a developing member.

10. An electrophotographic image forming apparatus comprising the electrophotographic member as a developing member, wherein
the electrophotographic member has a conductive substrate and a conductive layer on the substrate,
the conductive layer comprises a compound having a structure represented by formula (1) and a structure represented by formula (2): 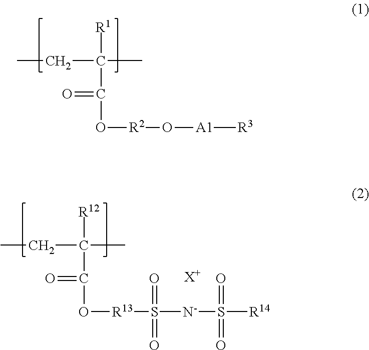
in formula (1),
R¹ represents a hydrogen atom or a methyl group,
R² represents a linear or branched alkylene group having 1 to 6 carbon atoms,
R³ represents an alkyl group having 1 to 6 carbon atoms,
A1 represents a linking group including a structure represented by (—CH₂CH₂—O—);
in formula (2),
R¹² represents a hydrogen atom or a methyl group,
R¹³ represents a linear or branched alkylene group having 1 to 7 carbon atoms,
R¹⁴ represents a fluorine atom or a linear or branched perfluoroalkyl group having 1 to 4 carbon atoms, and
X⁺ represents at least one selected from the group consisting of a lithium ion, a sodium ion, and a potassium ion.

11. A copolymer having a structure represented by formula (1) and a structure represented by formula (2): 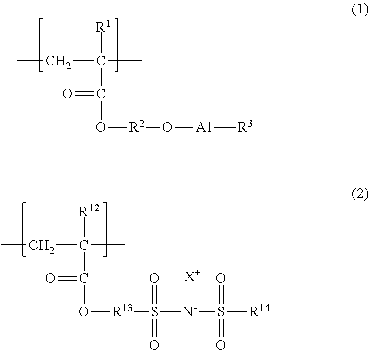
in formula (1),
R¹ represents a hydrogen atom or a methyl group,
R² represents a linear or branched alkylene group having 1 to 6 carbon atoms,
R³ represents an alkyl group having 1 to 6 carbon atoms,
A1 represents a linking group including a structure represented by (—CH₂CH₂—O—) and a structure represented by (—CH₂CH(CH₃)—O—);
in formula (2),
R¹² represents a hydrogen atom or a methyl group,
R¹³ represents a linear or branched alkylene group having 1 to 7 carbon atoms,
R¹⁴ represents a fluorine atom or a linear or branched perfluoroalkyl group having 1 to 4 carbon atoms,
X⁺ represents at least one selected from the group consisting of a lithium ion, a sodium ion, and a potassium ion.

12. The copolymer according to claim 11, wherein the structure represented by formula (1) is a structure represented by formula (1-1): 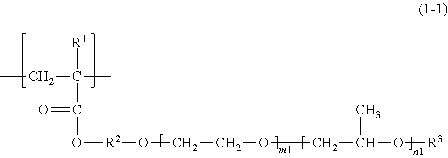
R² represents a linear or branched alkylene group having 1 to 6 carbon atoms,
R³ represents an alkyl group having 1 to 6 carbon atoms,
m1 and n1 are average addition mole numbers, where m1 is an integer of 1 or greater, and n1 is an integer of 0 or greater; wherein
arrangements of the structure represented by (—CH₂—CH₂—O—) and the structure represented by (—CH₂—CH(CH₃)—O—) may be a block copolymer or a random copolymer.

13. The copolymer according to claim 11, wherein a number-average molecular weight (Mn) of the copolymer is 500 to 100,000.

14. The copolymer according to claim 11, wherein a molar ratio of the structure represented by formula (1) to the structure represented by formula (2) (formula (1) formula (2)) is 60:40 to 95:5.
